(19) United States
(12) Patent Application Publication
(10) Pub. No.: US 2024/0276477 A1
(43) Pub. Date: Aug. 15, 2024

(54) BEAM MANAGEMENT FOR NON-ANCHOR CARRIERS

(71) Applicant: QUALCOMM Incorporated, San Diego, CA (US)

(72) Inventors: Konstantinos DIMOU, New York, NY (US); Jae Ho RYU, San Diego, CA (US); Changhwan PARK, San Diego, CA (US)

(21) Appl. No.: 18/169,157

(22) Filed: Feb. 14, 2023

(51) Int. Cl. H04W 72/044; H04W 72/53

(52) U.S. Cl. CPC H04W 72/046; H04W 72/53

(57) ABSTRACT

Various aspects of the present disclosure generally relate to wireless communication. In some aspects, a network node may transmit a first reference signal using a first network transmit beam corresponding to a first carrier. The network node may transmit, based on a beam metric associated with the first network transmit beam and a second network transmit beam corresponding to a second carrier, a network transmit beam refinement procedure indication indicating whether a network transmit beam refinement procedure is to be performed. Numerous other aspects are described.

### INTRODUCTION

Aspects of the present disclosure generally relate to wireless communication and to techniques and apparatuses for beam management.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a network node for wireless communication. The network node may include a memory and one or more processors coupled to the memory. The one or more processors may be configured to output for transmission a first reference signal using a first network transmit beam corresponding to a first carrier. The one or more processors may be configured to output for transmission, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to a network node for wireless communication. The network node may include a memory and one or more processors coupled to the memory. The one or more processors may be configured to output for transmission a first reference signal using a first network transmit beam corresponding to a first carrier. The one or more processors may be configured to output for transmission, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to a user equipment (UE) for wireless communication. The UE may include a memory and one or more processors coupled to the memory. The one or more processors may be configured to obtain a first reference signal using a first network transmit beam corresponding to a first carrier. The one or more processors may be configured to obtain, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to a UE for wireless communication. The user equipment may include a memory and one or more processors coupled to the memory. The one or more processors may be configured to obtain a first reference signal using a first network transmit beam corresponding to a first carrier. The one or more processors may be configured to obtain, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to a method of wireless communication performed at a network node. The method may include transmitting a first reference signal using a first network transmit beam corresponding to a first carrier. The method may include transmitting, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to a method of wireless communication performed at a network node. The method may include transmitting a first reference signal using a first network transmit beam corresponding to a first carrier. The method may include transmitting, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to a method of wireless communication performed at a UE. The method may include receiving a first reference signal using a first network transmit beam corresponding to a first carrier. The method may include receiving, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to a method of wireless communication performed at a UE. The method may include receiving a first reference signal using a first network transmit beam corresponding to a first carrier. The method may include receiving, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to a non-transitory computer-readable medium that stores a set of instructions for wireless communication by a network node. The set of instructions, when executed by one or more processors of the network node, may cause the network node to transmit a first reference signal using a first network transmit beam corresponding to a first carrier. The set of instructions, when executed by one or more processors of the network node, may cause the network node to transmit, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to a non-transitory computer-readable medium that stores a set of instructions for wireless communication by a network node. The set of instructions, when executed by one or more processors of the network node, may cause the network node to transmit a first reference signal using a first network transmit beam corresponding to a first carrier. The set of instructions, when executed by one or more processors of the network node, may cause the network node to transmit, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to a non-transitory computer-readable medium that stores a set of instructions for wireless communication by a UE. The set of instructions, when executed by one or more processors of the UE, may cause the UE to receive a first reference signal using a first network transmit beam corresponding to a first carrier. The set of instructions, when executed by one or more processors of the UE, may cause the UE to receive, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to a non-transitory computer-readable medium that stores a set of instructions for wireless communication by a UE. The set of instructions, when executed by one or more processors of the UE, may cause the UE to receive a first reference signal using a first network transmit beam corresponding to a first carrier. The set of instructions, when executed by one or more processors of the UE, may cause the UE to receive, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to an apparatus for wireless communication. The apparatus may include means for transmitting a first reference signal using a first network transmit beam corresponding to a first carrier. The apparatus may include means for transmitting, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to an apparatus for wireless communication. The apparatus may include means for transmitting a first reference signal using a first network transmit beam corresponding to a first carrier. The apparatus may include means for transmitting, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Some aspects described herein relate to an apparatus for wireless communication. The apparatus may include means for receiving a first reference signal using a first network transmit beam corresponding to a first carrier. The apparatus may include means for receiving, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Some aspects described herein relate to an apparatus for wireless communication. The apparatus may include means for receiving a first reference signal using a first network transmit beam corresponding to a first carrier. The apparatus may include means for receiving, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4D are diagrams illustrating examples of beam management procedures, in accordance with the present disclosure.

FIG. 5 is a diagram illustrating a first example procedure for synchronization with a synchronization signal block (SSB)-less cell.

FIG. 6 is a diagram illustrating a second example procedure for synchronization with the SSB-less cell.

FIG. 7 is a diagram illustrating a third example procedure for synchronization with the SSB-less cell.

FIG. 8 is a diagram illustrating an example of beam squinting in inter-band carrier aggregation.

FIG. 9 is a diagram of an example associated with beam management for non-anchor carriers, in accordance with the present disclosure.

FIG. 10 is a call flow diagram of an example associated with beam management for non-anchor carriers, in accordance with the present disclosure.

FIG. 11 is a diagram illustrating an example process performed, for example, by a network node, in accordance with the present disclosure.

FIG. 12 is a diagram illustrating an example process performed, for example, by a network node, in accordance with the present disclosure.

FIG. 13 is a diagram illustrating an example process performed, for example, by a UE, in accordance with the present disclosure.

FIG. 14 is a diagram illustrating an example process performed, for example, by a UE, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

FIG. 18 is a diagram of an example apparatus for wireless communication, in accordance with the present disclosure.

FIG. 19 is a diagram illustrating an example of a hardware implementation for an apparatus employing a processing system, in accordance with the present disclosure.

FIG. 20 is a diagram illustrating an example of an implementation of code and circuitry for an apparatus, in accordance with the present disclosure.

### DETAILED DESCRIPTION

Some aspects of the techniques and apparatuses described herein may relate to beam management associated with a non-anchor carrier based on an anchor carrier.

To support millimeter wave (mmW) communications, network nodes may be outfitted with antenna arrays having the capability to generate beams and perform beamforming. “Beam” may refer to a directional transmission such as a wireless signal that is transmitted in a direction of a receiver network node. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

In wireless communications, beamforming may be used to compensate for power loss in communication between a transmitter and receiver. However, due to the uncertain nature of a wireless environment and unexpected blocking, a beam may be vulnerable to beam failure.

In some cases, a user equipment (UE) and a network node can perform a beam management procedure in which the receiver network node and the transmitter network node identify beam pairs to be used for communication. The beam management procedure can include the transmitter network node performing beam sweeping over multiple transmit (Tx) beams and/or the receiver network node performing receive (Rx) beam sweeping over multiple Rx beams. The beam management procedure can enable the receiver network node to measure CSI-RSs on different transmit beams using different receive beams to support selection of transmitter network node transmit beams/receiver network node receive beam(s) beam pair(s). The beam pairs may be selected, for example, based on measurements of reference signal received power (RSRP).

In some implementations, three levels of beam management are used with various selection processes. For example, a first beam management procedure (a P1 beam management procedure), is used to enable UE measurement of different (wide) network node transmission beams to support selection of network transmit beams and/or UE receive beams. Beamforming at the network node can include a network transmit beam sweep associated with a set of different network transmit beams. For example, a network node may transmit a set of reference signals (e.g., a synchronization signal block (SSB) burst set or a channel state information reference signal (CSI-RS) resource set) and the UE may obtain and report measurements associated with the set of reference signals. The UE also may identify and report a best network transmit beam based on the measurements. Beamforming at the UE can include a UE receive beam sweep from a set of UE receive beams. For example, the UE can identify and report the best receive beam or beams together with corresponding signal measurements (e.g., a layer 1 reference signal received power (RSRP)), based on measurements associated with the reference signal set. A second beam management procedure (a P2 beam management procedure) can be used to enable UE measurement on different (narrow) network transmit beams to narrow the selection of network transmit beams. P2 beam management procedures may be performed on a possibly smaller set of network transmit beams for beam refinement than in the P1 beam management procedure. For example, a network node may transmit UE-specific CSI-RS resources, which can be transmitted using narrow beams that are beamformed to provide more narrow beam footprints within the wider footprint of a beam selected in the P1 beam management procedure. The UE may further identify and report the best network transmit beam or beams based on measurements associated with the beamformed CSI-RS resources. In some implementations, the P2 beam management procedure can be considered a special case of a P1 beam management procedure, in which one or more narrower network transmit beams are selected. A third beam management procedure (a P3 beam management procedure) can be used to enable UE measurement on the selected network transmit beam or beams to narrow a selection of the UE receive beam in the case in which the UE uses beamforming.

Carrier aggregation (CA) is a technology that enables two or more component carriers (CCs) (sometimes referred to as carriers) to be combined (e.g., into a single channel) for a single UE to enhance data capacity. A carrier is a modulated waveform that conveys one or more physical channels. A carrier can be associated with a cell, which is a radio network object that can be identified by a UE. Carriers can be combined in the same or different frequency bands. Additionally, or alternatively, contiguous or non-contiguous carriers can be combined. In CA, a UE can be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling. A UE can switch between carriers.

A network operating using CA may consume energy using multiple carriers. To mitigate energy consumption and/or other potential issues, in some cases, inter-band CA (e.g., CA with carriers in different frequency bands) may be configured for a UE with an anchor carrier and one or more non-anchor carriers. In some aspects, an anchor carrier is a carrier that may carry SSBs and/or system information (SI). For example, a network node may transmit SSBs on an anchor carrier to facilitate a P1 beam management procedure, as described above. A non-anchor carrier is a carrier that does not carry SSBs and/or SI. For example, a non-anchor carrier may be an SSB-less carrier. An SSB-less carrier is a carrier, in a set of aggregate carriers, that does not transmit SSBs. For example, according to one or more aspects, a network node may not transmit any broadcast transmissions (e.g., SSBs, SI, and/or paging messages) on an SSB-less carrier. In some aspects, the anchor carrier may be the Pcell and the one or more non-anchor carriers may be Scells. In some cases, the set of aggregated carriers may form a virtual cell for communications with a UE. For example, the set of aggregated carriers may be associated with a virtual cell identifier. Because the network node does not transmit SSBs on non-anchor carriers, the use of non-anchor carriers may result in energy savings. Non-anchor carriers also may improve resource utilization by reducing downlink overhead and allowing the network deeper sleep (e.g., longer sleep time, different level of sleep) to conserve more power.

In some aspects, an anchor carrier (sometimes referred to as an “anchor cell”) in a different frequency band than a non-anchor carrier may be used for downlink beam management of the non-anchor carrier. For example, a UE may report, to a network node, RSRP measurements for a plurality of downlink reference signals transmitted via the anchor carrier, and the network node may determine a downlink beam for the non-anchor carrier based at least in part on the RSRP measurements using a beam mapping function.

In some aspects, performing a P2 beam management procedure and/or a P3 beam management procedure associated with a non-anchor carrier may be used to mitigate frequency and/or time synchronization challenges that may arise as a result of a difference in frequency between the anchor carrier and the non-anchor carrier. Further, when the anchor carrier and the non-anchor carrier use the same reference signal for beam management, beam squinting (a divergence between a direction associated with a beam associated with a first carrier and a direction associated with a beam associated with a second carrier) may cause the non-anchor carrier to be associated with a beam direction that is different than a beam direction associated with transmission of an SSB via the anchor carrier, thereby resulting in transmissions via the non-anchor cell being received with less power than transmissions via the anchor cell.

In some cases, for example, the network can assist the UE to perform limited range P3 beam sweeping, under the assumption that the transmitted beam (e.g., TCI state) is the same in the anchor carrier and the non-anchor carrier. In one example, the limited range P3 beam sweeping may be performed based on the TCI state corresponding to the transmitted beam being the same in the anchor carrier and non-anchor carrier. However, in a case of beam squinting, the TCI state corresponding to the transmitted beam may not be the same in the anchor and non-anchor carriers, and thus, a P2 beam management procedure may result in acquisition of a beam associated with a non-anchor carrier that may not be suitable for communications therewith. Beam squinting is a situation in which a first angle of departure (AoD) associated with a beam corresponding to a first carrier is divergent (different) from a second AoD associated with a beam corresponding to a second carrier. An AoD is an angle between a transmission direction associated with a beam and a normal direction associated with an antenna element corresponding to the beam. In some aspects, beam squinting may be defined based on a difference between the first AoD and the second AoD satisfies a threshold. For example, if beam squinting is such that the transmitted beam at the non-anchor carrier is diverged by a large angle from the transmitted beam at the anchor carrier, the propagation multipath profile (e.g., a set of multipath propagation characteristics associated with a time (e.g., delay characteristics), frequency (e.g., phase characteristics), and/or spatial (e.g., angle characteristics) domain will be different in the anchor carrier compared to the propagation multipath profile in the non-anchor carrier as a consequence of the resulting differences in angle of arrival at the UE, differences in distance in the UE, and/or differences in physical paths (and/or obstacles therein) traversed by signals via the different carriers. Thus, the limited range P3 beam sweeping may be confined to an angle range that excludes a better network transmit beam.

Some aspects of the techniques and apparatuses described herein may provide for acquisition of a suitable non-anchor carrier network transmit beam based on an anchor carrier network transmit beam. For example, in some aspects, a network node may determine, based on a beam metric, whether a first network transmit beam (e.g., TCI state) associated with the anchor carrier is suitable for use with the non-anchor carrier. The beam metric may be associated with the first network transmit beam and a second network transmit beam corresponding to the non-anchor carrier. For example, the beam metric may be a function of a characteristic of the first network transmit beam and a characteristic of the second network transmit beam. In some aspects, for example, the beam metric may include an angle divergence value equal to a difference between a first angle of departure (AoD) associated with the first network transmit beam and a second AoD associated with the second network transmit beam.

In some aspects, the network node may determine whether the beam metric satisfies a beam refinement condition. The beam refinement condition may include one or more conditions that, when satisfied, indicate that a network transmit beam refinement procedure should be performed. The network transmit beam refinement procedure may be a limited to P2 beam management procedure during which the network node sweeps among a limited number of network transmit beams to facilitate acquisition of a suitable beam associated with the non-anchor carrier. In some aspects, the beam metric may fail to satisfy the beam refinement condition, in which case, the network node may determine that the second network transmit beam is suitable. For example, the second network transmit beam may be similar to, or the same as, the first network transmit beam and, therefore, may have similar characteristics. In this case, a beam refinement procedure may not be performed, and the TCI state associated with the anchor carrier may be used for the non-anchor carrier. The network node may transmit, to the UE, a network transmit beam refinement procedure communication indicating, based on whether the beam refinement condition is satisfied, whether a network transmit beam refinement procedure is to be performed. Some aspects may therefor result in faster beam acquisition in the non-anchor carrier, leading to lower UE power consumption and network energy savings, thereby positively impacting network performance.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Some aspects of the techniques and apparatuses described herein may provide for acquisition of a suitable non-anchor carrier network transmit beam based on an anchor carrier network transmit beam. For example, in some aspects, a network node may determine, based on a beam squinting measurement, whether a beam associated with the anchor carrier is suitable for use with the non-anchor carrier. In aspects in which the beam is unsuitable, based on a beam squinting condition, the network node may perform a limited range P2 beam sweeping to facilitate acquisition of a suitable beam associated with the non-anchor carrier.

In this way, the network node may conserve power by foregoing transmission of an SSB on a non-anchor carrier. UE performance may be improved for the non-anchor carriers using limited range P2 beam sweeping thus improving the synchronization between the UE and the non-anchor carrier.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

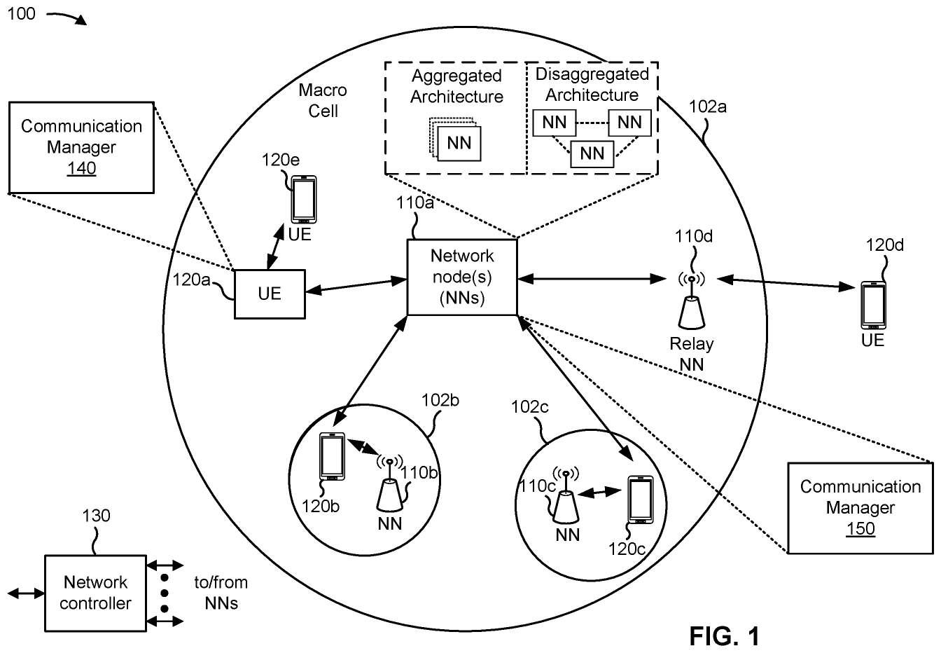

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., the network node 110) may include a communication manager 150. As described in more detail elsewhere herein, the communication manager 150 may transmit a first reference signal using a first network transmit beam corresponding to a first carrier; and transmit, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier. Additionally, or alternatively, the communication manager 150 may perform one or more other operations described herein.

In some aspects, a network node (e.g., the network node 110) may include a communication manager 150. As described in more detail elsewhere herein, the communication manager 150 may transmit a first reference signal using a first network transmit beam corresponding to a first carrier; and transmit, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier. Additionally, or alternatively, the communication manager 150 may perform one or more other operations described herein.

In some aspects, a UE (e.g., the UE 120) may include a communication manager 140. As described in more detail elsewhere herein, the communication manager 140 may receive a first reference signal using a first network transmit beam corresponding to a first carrier; and receive, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier. Additionally, or alternatively, the communication manager 140 may perform one or more other operations described herein.

In some aspects, a UE (e.g., the UE 120) may include a communication manager 140. As described in more detail elsewhere herein, the communication manager 140 may receive a first reference signal using a first network transmit beam corresponding to a first carrier; and receive, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier. Additionally, or alternatively, the communication manager 140 may perform one or more other operations described herein.

As indicated above, FIG. 1 is provided as an example. Other examples may differ from what is described with regard to FIG. 1.

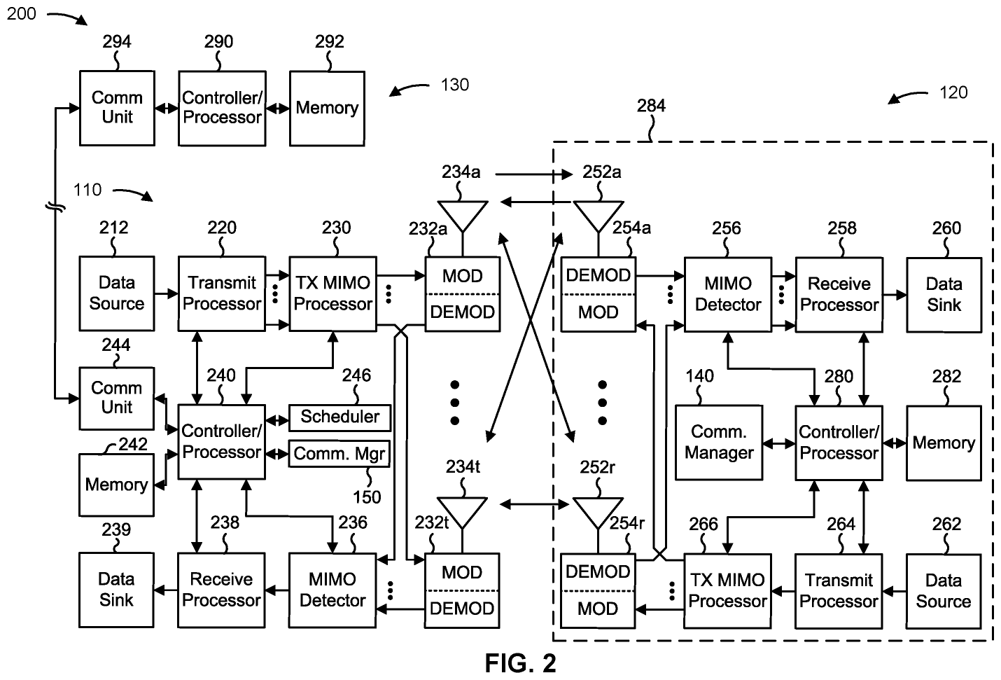

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type.

A QCL type may indicate one or more spatial parameters to be derived from the source signal. For example, in a wireless network, the concept of quasi-co-location is typically used to define a relationship that links two or more reference signals according to certain rules. For example, if beams used to transmit different downlink reference signals are quasi-co-located (QLCed), one or more transmission properties associated with one downlink reference signal can be used to infer the corresponding one or more properties of another downlink reference signal, such as a Doppler shift, a Doppler spread, an average delay, a delay spread, a spatial reception parameter (e.g., a dominant angle of arrival, a frequency shift, an average gain, an average received power, a received timing), and/or the like. The QCL relationship may allow the UE to perform channel estimation by reusing digital baseband processing according to certain rules (e.g., by avoiding having to calculate a Doppler shift or other channel properties for a reference signal QCLed with another reference signal for which the Doppler shift was already calculated). For example, if the QCL relationship has a first type (e.g., ‘QCL-TypeA’), the UE may assume that the QCLed reference signals have the same Doppler shift, Doppler spread, average delay, and delay spread. In another example, if the QCL relationship has a second type (e.g., ‘QCL-TypeB’), the UE may assume that the QCLed reference signals have the same Doppler shift and Doppler spread. In other examples, the UE may assume that QCLed reference signals have the same Doppler shift and average delay if the QCL relationship has a third type (e.g., ‘QCL-TypeC’), may assume that QCLed reference signals have the same spatial reception parameters if the QCL relationship has a fourth type (e.g., ‘QCL-TypeD’), and/or the like. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD), and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for CA scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

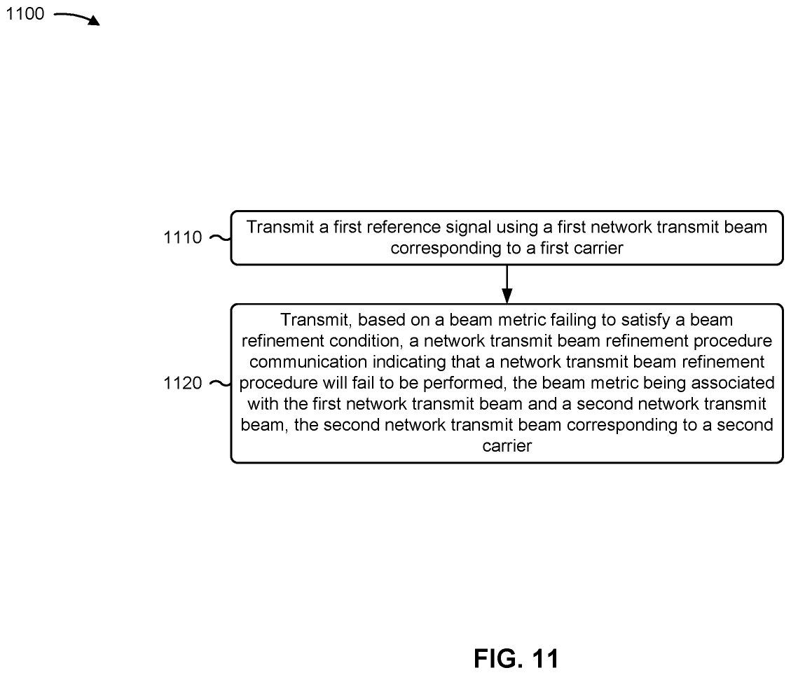

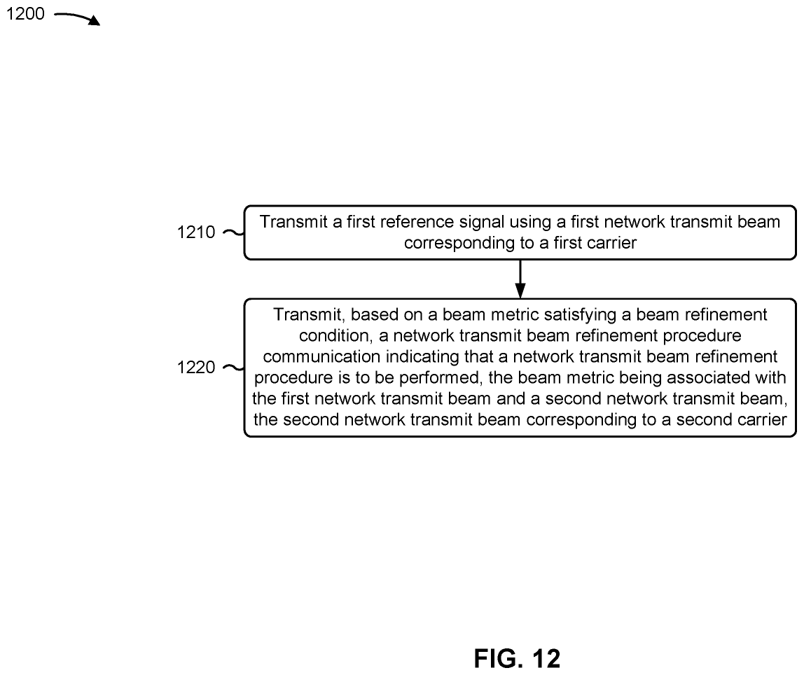

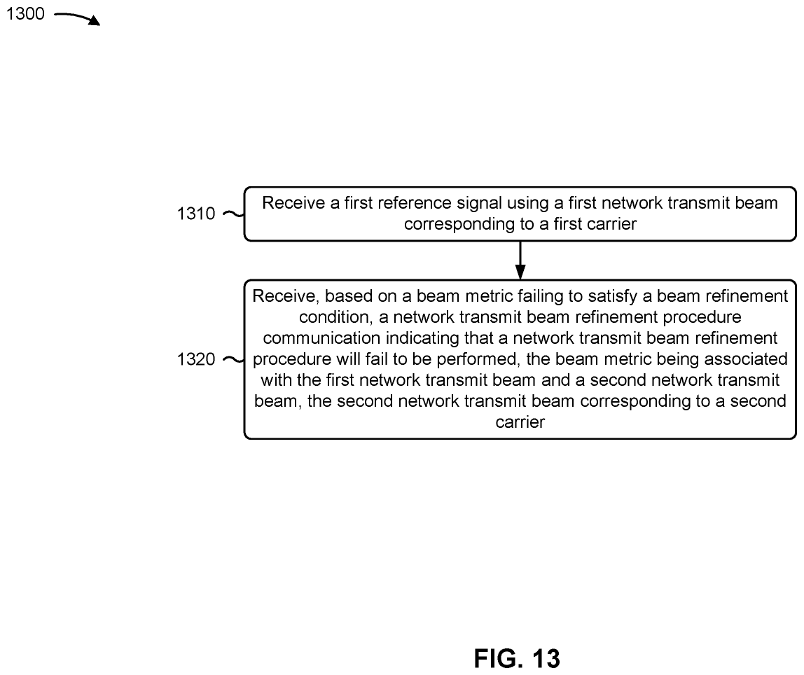

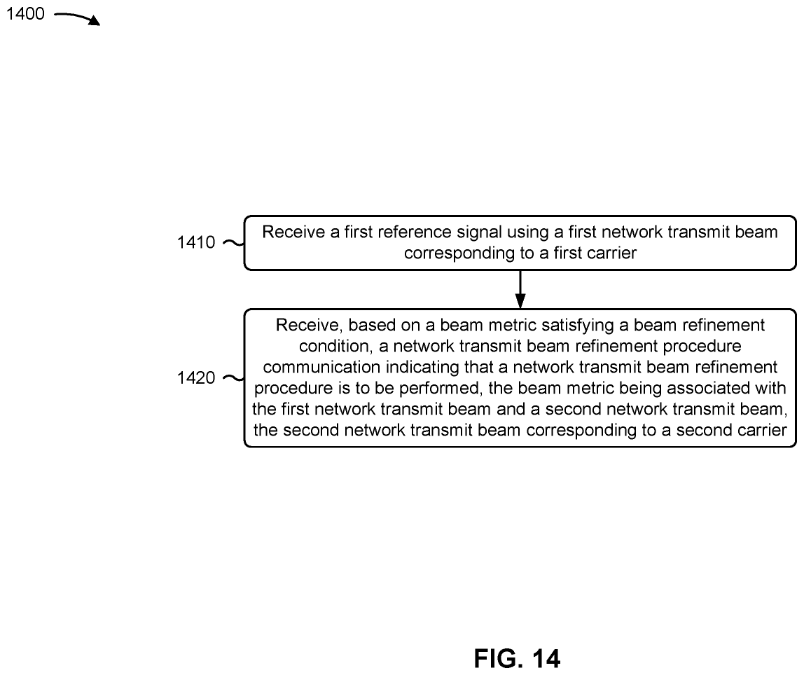

The controller/processor 240 of the network node 110, the controller/processor 280 of the UE 120, and/or any other component(s) of FIG. 2 may perform one or more techniques associated with beam management for non-anchor carriers, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, a network node (e.g., the network node 110) includes means for transmitting a first reference signal using a first network transmit beam corresponding to a first carrier; and/or means for transmitting, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node (e.g., the network node 110) includes means for transmitting a first reference signal using a first network transmit beam corresponding to a first carrier; and/or means for transmitting, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., the UE 120) includes means for receiving a first reference signal using a first network transmit beam corresponding to a first carrier; and/or means for receiving, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for receiving a first reference signal using a first network transmit beam corresponding to a first carrier; and/or means for receiving, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

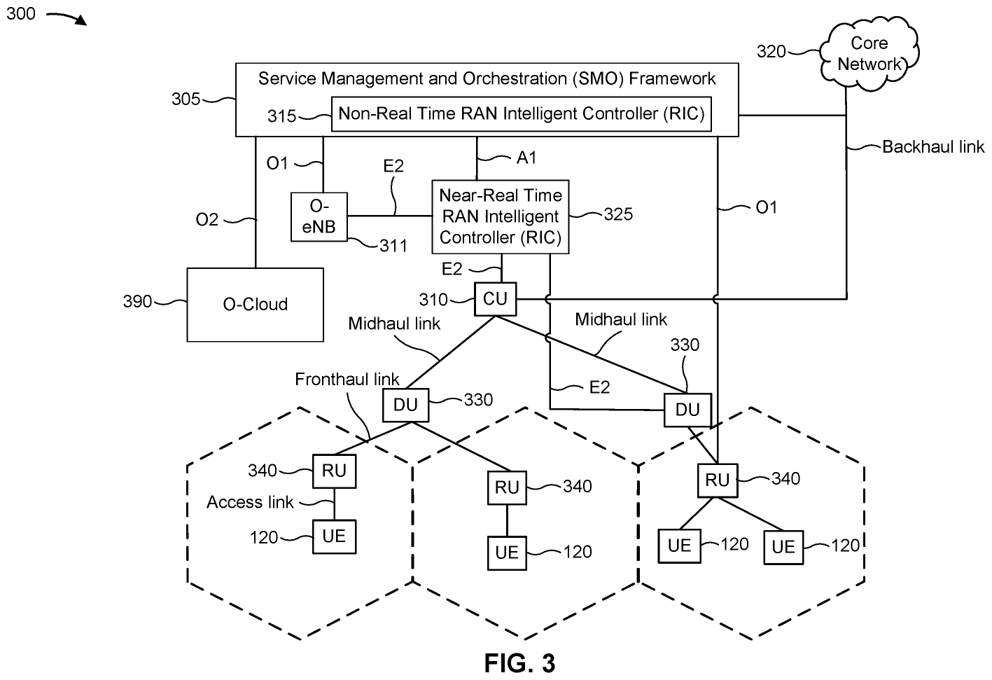

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

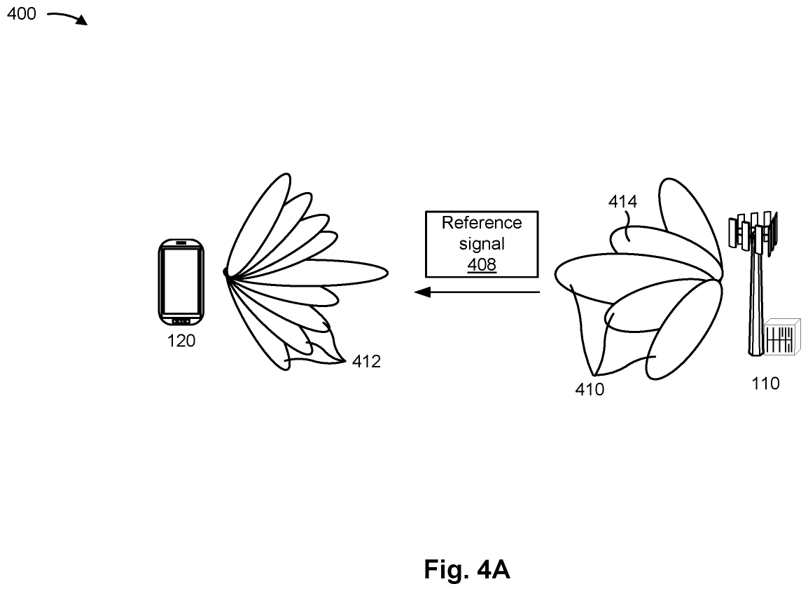

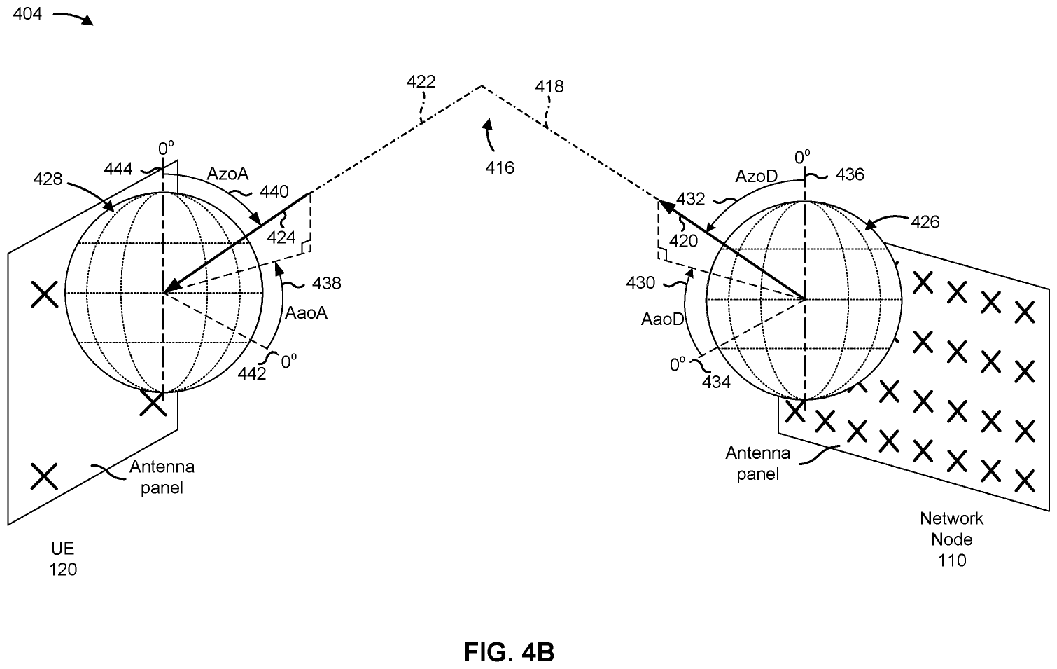

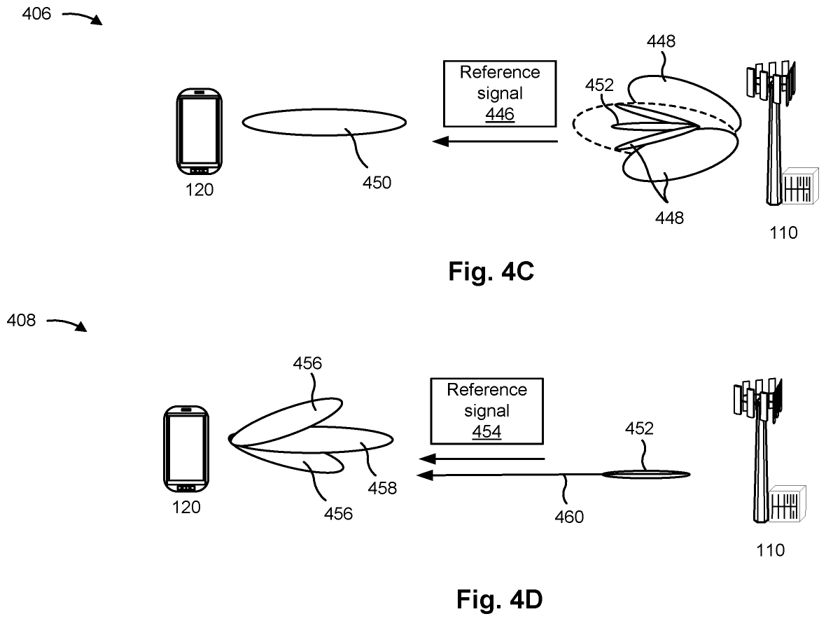

FIGS. 4A-4D are diagrams illustrating examples 400, 402, 404, and 406 associated with beam management procedures, in accordance with the present disclosure. As shown in FIGS. 4A-4D, examples 400, 402, 404, and 406 include a UE 120 in communication with a network node 110 in a wireless network (e.g., wireless network 100). The devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4A, example 400 may include a network node 110 (e.g., one or more network node devices such as an RU, a DU, and/or a CU, among other examples) and a UE 120 communicating to perform beam management using reference signals (e.g., SSBs and/or CSI-RSs). Example 400 depicts a first beam management procedure. In some cases, the first beam management procedure may be referred to as a P1 beam management procedure, beam selection procedure, an initial beam acquisition procedure, a beam sweeping procedure, a cell search procedure, and/or a beam search procedure. In some cases, for example, reference signals 408 may be configured to be transmitted from the network node 110 to the UE 120. The reference signals 408 may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams 410. The network node 110 may transmit a reference signal (e.g., an SSB) 408 using each transmit beam 410 for beam management. To enable the UE 120 to perform receive (Rx) beam sweeping, the network node 110 may use a transmit beam 410 to transmit (e.g., with repetitions) each reference signal 408 at multiple times within the same reference signal resource set so that the UE 120 can sweep through receive beams 412 in multiple transmission instances. For example, if the network node 110 has a set of N transmit beams 410 and the UE 120 has a set of M receive beams 412, the reference signal 408 may be transmitted on each of the N transmit beams 410 M times so that the UE 120 may receive M instances of the reference signal per transmit beam 410. In other words, for each transmit beam 410 of the network node 110, the UE 120 may perform beam sweeping through the receive beams 412 of the UE 120. As a result, the first beam management procedure may enable the UE 120 to measure a reference signal on different transmit beams 410 using different receive beams 412 to support selection of network node 110 transmit beams 410/UE 120 receive beam(s) 412 beam pair(s). The UE 120 may report the measurements to the network node 110 to enable the network node 110 to select one or more beam pair(s) for communication between the network node 110 and the UE 120.

In some cases involving CA, as described herein, a reference signal 408 such as an SSB corresponding to a first carrier can be used to identify a network transmit beam 410 to be used with a second carrier. In some cases, for example, a TCI state of a network transmit beam 410 corresponding to a first carrier may be used for a network transmit beam 414 of a second carrier based on a difference between a first AoD associated with the network transmit beam 410 and a second AoD associated with the network transmit beam 414 satisfying a threshold. As described above, an AoD is an angle between a transmission direction (e.g., a beam direction) and a normal direction (e.g., a perpendicular direction) associated with an antenna element. Because beams are transmitted in three-dimensional space, an AoD may be represented in terms of component angles such as angles of zenith and angles of azimuth. In some cases, an angle of arrival (AoA) may be used in place of an AoD.

As shown in FIG. 4B, example 404 may include a network node 110 (represented as having an antenna panel) and a UE 120 (represented as having an antenna panel) communicating to perform beam management using reference signals. As shown in example 404, a channel 416 (sometimes referred to as a “channel cluster”) may include a combination of a transmission path 418 (represented by an AoD 420 and a gain along the AoD 420) and a reception path 422 (represented by an AoA 424 and a gain along the AoA 424). As shown, the AoD 420 and AoA 424 may be represented in the context of a respective spherical coordinate system 426 or 428. In some examples, the coordinate system 426 and the coordinate system 428 may be the same system. In some other examples, the coordinate system 426 may be different than the coordinate system 428 (e.g., different in orientation and/or scale). An AoA includes an azimuth angle and an elevation angle (sometimes referred to as a zenith angle). Similarly, an AoD includes an azimuth angle and an elevation angle (zenith angle). Although an azimuth angle of arrival is sometimes denoted as “AoA” and a zenith angle of arrival is sometimes denoted as “ZoA,” the term “AoA” in the present disclosure means “angle of arrival” and is intended to refer to one or more aspects of an angle of arrival such as, for example, an azimuth angle of arrival, a zenith angle of arrival, or a combination of the azimuth angle of arrival and the zenith angle of arrival. To facilitate clarity of the description, “azimuth angle of arrival” is denoted herein as “AaoA” and “zenith angle of arrival” is denoted herein as “AzoA.” Similarly, although a zenith angle of departure is sometimes denoted as “AoD” and a zenith angle of departure is sometimes denoted as “ZoD,” the term “AoD” in the present disclosure means “angle of departure” and is intended to refer to one or more aspects of an angle of departure such as, for example, an azimuth angle of departure, a zenith angle of departure, or the combination of the azimuth angle of departure and the zenith angle of departure. To facilitate clarity of the description, “azimuth angle of departure” is denoted herein as “AaoD” and “zenith angle of departure” is denoted herein as “AzoD.”

As shown, the AoD 420 may include a path (e.g., a direction) determined by a combination of an AaoD 430 and an AzoD 432. The AaoD 430 may be an angle of azimuth defined with respect to an azimuthal axis 434, and the AzoD 432 may be an angle of zenith defined with respect to a zenith axis 436. Similarly, the AoA 424 may include a path (e.g., a direction) determined by a combination of an AaoA 438 and an AzoA 440. The AaoA 438 may be an angle of azimuth defined with respect to an azimuthal axis 442, and the AzoA 440 may be an angle of zenith defined with respect to a zenith axis 444.

As shown in FIG. 4C, example 406 may include a network node 110 and a UE 120 communicating to perform beam management using reference signals 446. Example 406 depicts a second beam management procedure. The second beam management procedure may be referred to as a P2 beam management procedure, beam refinement procedure, a network node beam refinement procedure, a TRP beam refinement procedure, and/or a transmit beam refinement procedure. As shown in FIG. 4 and example 406, reference signals (e.g., SSBs and/or CSI-RSs) 446 may be configured to be transmitted from the network node 110 to the UE 120. The reference signals 446 may be configured to be aperiodic (e.g., using DCI). The second beam management procedure may include the network node 110 performing beam sweeping over one or more transmit beams 448. In some aspects, the one or more transmit beams 448 may be a subset of all transmit beams 410 associated with the network node 110 (e.g., determined based at least in part on measurements reported by the UE 120 in connection with the first beam management procedure). In some other aspects, the one or more transmit beams 448 may be narrower beams than the beam or beams identified during the first beam management procedure. The network node 110 may transmit a reference signal 446 using each transmit beam 448 of the one or more transmit beams 448 for beam management. The UE 120 may measure each reference signal 446 using a single (e.g., a same) receive beam 450 (e.g., determined based at least in part on measurements performed in connection with the first beam management procedure). The second beam management procedure may enable the network node 110 to select a best transmit beam 452 based at least in part on measurements of the reference signals 446 (e.g., measured by the UE 120 using the single receive beam) reported by the UE 120.

As shown in FIG. 4D, example 408 depicts a third beam management procedure. The third beam management procedure may be referred to as a P3 beam management procedure, beam refinement procedure, a UE beam refinement procedure, and/or a receive beam refinement procedure. As shown in FIG. 4 and example 420, one or more reference signals 454 may be configured to be transmitted from the network node 110 to the UE 120. The reference signals 454 may be configured to be aperiodic (e.g., using DCI). The third beam management process may include the network node 110 transmitting the one or more reference signals 454 using a single transmit beam 452 (e.g., determined based at least in part on measurements reported by the UE 120 in connection with the first beam management procedure and/or the second beam management procedure). To enable the UE 120 to perform receive beam sweeping, the network node 110 may use a transmit beam 452 to transmit (e.g., with repetitions) reference signals 454 at multiple times within the same reference signal resource set so that UE 120 can sweep through one or more receive beams 456 in multiple transmission instances. The one or more receive beams 456 may be a subset of all receive beams 412 associated with the UE 120 (e.g., determined based at least in part on measurements performed in connection with the first beam management procedure and/or the second beam management procedure). The third beam management procedure may enable the network node 110 and/or the UE 120 to select a best receive beam 458 based at least in part on reported measurements received from the UE 120 (e.g., of the reference signal of the transmit beam using the one or more receive beams).

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in a radio resource control (RRC) message, DCI, and/or another signaling message. In some aspects, carrier aggregation may be configured in an inter-band non-contiguous mode where the aggregated carriers are non-contiguous to one another and are in different bands.

In carrier aggregation, a UE 120 may be configured with a primary carrier or primary cell (Pcell) and one or more secondary carriers or secondary cells (Scells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some cases, inter-band carrier aggregation (e.g., carrier aggregation with carriers in different frequency bands) may be configured for a UE (e.g., UE 120) with a carrier that transmits SSBs and one or more SSB-less carriers. An SSB-less carrier is a carrier, in a set of aggregate carriers, that does not transmit SSBs. For example, a network node (e.g., network node 110) may not transmit any broadcast transmissions (e.g., SSBs, system information (SI), and/or paging messages) on an SSB-less carrier. A set of aggregated carriers for inter-band carrier aggregation can includes an anchor carrier, on which SSBs are transmitted, and two SSB-less carriers. For example, the anchor carrier may be the Pcell and the anchor carriers may be Scells. In some cases, the set of aggregated carriers may form a virtual cell for communications with a UE. For example, the set of aggregated carriers may be associated with a virtual cell identifier.

In some cases, a network node may transmit SSBs and SI on the anchor carrier, but not on the non-anchor carriers (e.g., the SSB-less carriers). The SSBs and SI transmitted on the anchor carrier may provide time and frequency synchronization information and SI for the other carriers (e.g., the non-anchor carriers), as well as for the anchor carrier. In some cases, transmitting SSBs on the anchor carrier (e.g., the Pcell), but not on the non-anchor carriers (e.g., the Scells) may improve Scell activation latency (e.g., because the UE does not receive a respective SSB on each Scell). Such improved Scell activation latency may facilitate efficient Scell activation and/or deactivation in accordance with the actual traffic associated with a UE, which may result in network power savings. Furthermore, not transmitting SSBs on the non-anchor carriers (e.g., the Scells) may result in improved resource utilization by reducing downlink overhead. This may allow for deeper network sleep for improved power savings.

In some examples, a transmission of a reference signal or a channel in a frequency band or carrier may have a QCL source directly or indirectly associated with an SSB transmitted in the band or carrier. However, an SSB-less carrier may carry no broadcast transmissions (e.g., SSBs, SI, and/or paging messages), and possibly no tracking reference signal (TRS), for network power savings. For example, an SSB-less carrier may carry only control channels and data channels.

As indicated above, FIGS. 4A-4D are provided as example of beam management procedures. Other examples of beam management procedures may differ from what is described with respect to FIGS. 4A-4D. For example, the UE 120 and the network node 110 may perform the third beam management procedure before performing the second beam management procedure, and/or the UE 120 and the network node 110 may perform a similar beam management procedure to select a UE transmit beam.

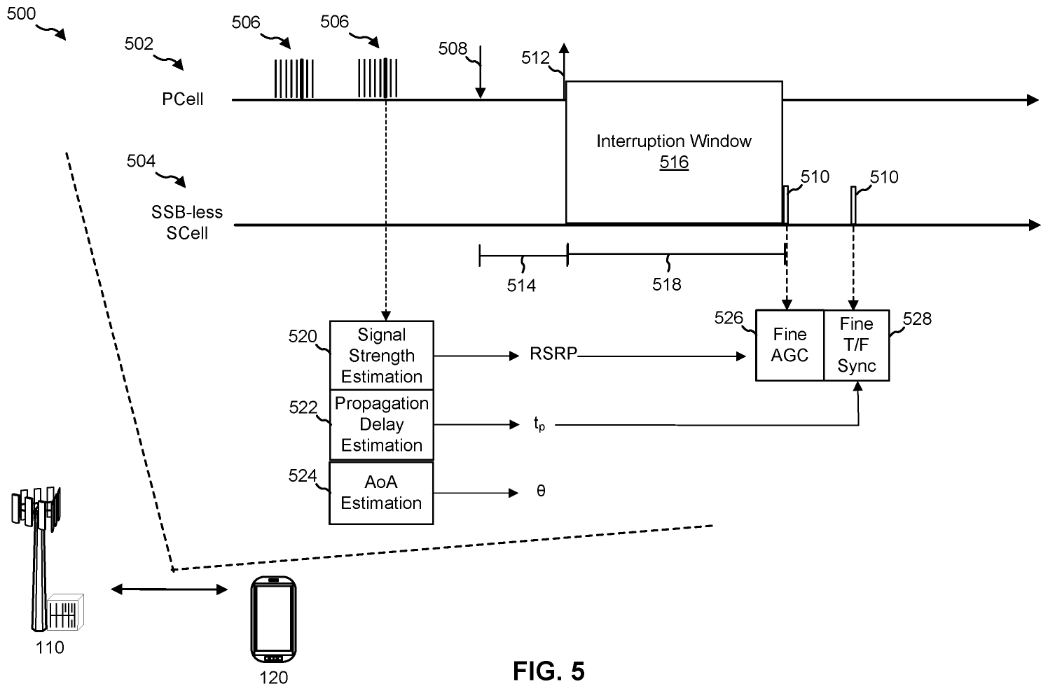

FIG. 5 is a diagram illustrating a first example procedure 500 for synchronization with an SSB-less SCell. As shown, a UE 120 and a network node 110 may communicate with one another. The UE 120 may initially be connected to a PCell 502 and may switch to connection with an SCell configured as an SSB-less cell 504. The PCell 502 may periodically transmit SSBs 506. The SSBs 506 may be transmitted on different beams, allowing the UE 120 to identify a best beam using a P1 beam management procedure. The SSBs 506 may also be used for measurements and maintaining time and frequency tracking loops.

The network node 110 may activate the SSB-less SCell 504 by transmitting a MAC-CE 508 on the PCell 502. The MAC-CE 508 may include a trigger for an A-TRS 510. The UE 120 may acknowledge the MAC-CE 508 by transmitting a HARQ-ACK 512. The UE 120 may transmit the HARQ-ACK 512 after a HARQ delay 514. In an aspect, the timing of the A-TRS 510 may be based on an interruption window 516 measured from the HARQ-ACK 512. The interruption window 516 may represent a time period when the UE 120 cannot use the same hardware (e.g., receive chain) as used for the PCell for the SCell. For instance, the UE 120 may tune the hardware for the different frequency band during the interruption window 516. A duration 518 of the interruption window 516 may be based on a MAC processing time (e.g., 3 ms). The network node 110 may start transmission of the A-TRS 510 at the end of the interruption window 516.

In an aspect, the UE 120 may synchronize to the SCell 504 based on both the A-TRS 510 and estimates according to measurements of the PCell. For example, the UE 120 may perform a signal strength estimation 520, propagation delay estimation 522, and/or an angle of arrival (AoA) estimation 524 based on the SSB 506. The signal strength estimation 520 may be based on a measurement of signal strength (e.g., reference signal received power (RSRP)) of the SSB 506. In an aspect, the estimated signal strength may be used for course AGC for the SCell 504.

The propagation delay estimation 522 may output a propagation time (tₚ) for the PCell 502. The timing for the SCell 504 may be within a timing error (t_{ε}) of the tₚ. The t_{ε} may be based on a distance between the UE 120 and the network node 110 that provides the PCell 502 and the SCell 504. For example, the UE 120 may estimate t_{ε} based on the RSRP from the signal strength estimation 520. In another example, the UE 120 may estimate the t_{ε} based on a propagation delay for the distance between the UE 120 and the network node 110, for example, using a formula or look up table. Alternatively, the UE 120 may receive a value of the t_{ε} from the PCell 502. For instance, the PCell 502 may calculate a maximum value of the t_{ε} based on a size of the SCell 504.

The AoA estimation 524 may be based on the receive beam of the PCell 502. For example, the AoA estimation 524 may be based on the SSB or the CSI-RS that is closer in time to an activation of the secondary cell (e.g., MAC-CE 516). The AoA estimation 524 may output an angle θ. In an aspect, the AoA of the SCell 504 may be within angle δ of the AoA.

When the UE 120 receives the A-TRS 510, the UE 120 may perform fine AGC 526 and fine time/frequency (T/F) synchronization 528 based on the A-TRS 510 and the signal strength estimation 520, propagation delay estimation 522, and/or AoA estimation 524. For instance, the fine AGC 526 may be based on the RSRP from the signal strength estimation 520 and a first slot of the A-TRS 510. The fine T/F synchronization 528 may be based on the tₚ and a second slot of the A-TRS 510.

As indicated above, FIG. 5 is provided as an example. Other examples may differ from what is described with regard to FIG. 5.

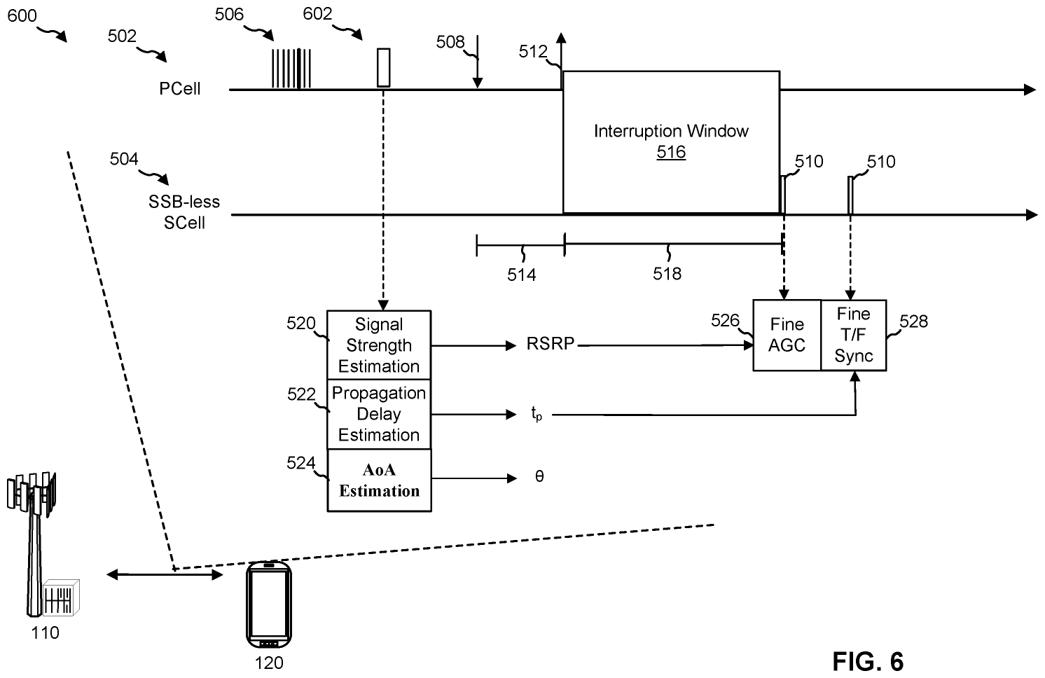

FIG. 6 is a diagram illustrating a second example procedure 600 for synchronization with the SSB-less SCell 504. The procedure 600 may be similar to the procedure 500 except the UE 120 may receive a CSI-RS 602 from the PCell 502. The signal strength estimation 520, propagation delay estimation 522, and/or AoA estimation 524 may be based on the CSI-RS 602 instead of the SSB 506. In an aspect, the UE 120 may perform the procedure 500 or the procedure 600 based on whether the SSB 506 or the CSI-RS 602 is received closer in time to the MAC-CE 508.

As indicated above, FIG. 6 is provided as an example. Other examples may differ from what is described with regard to FIG. 6.

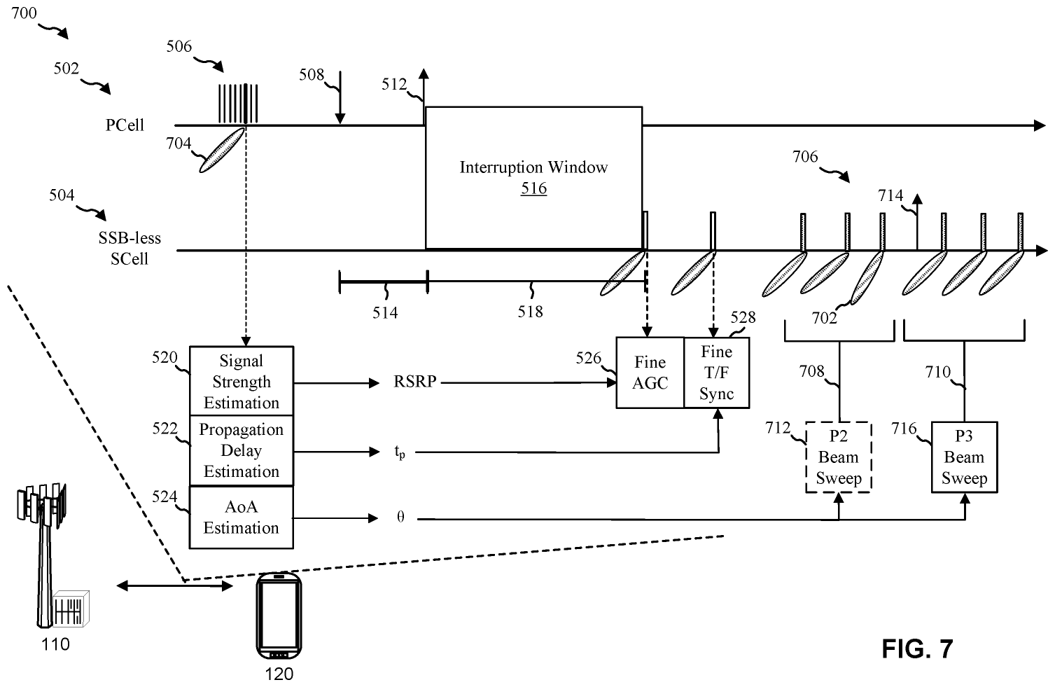

FIG. 7 is a diagram illustrating a third example procedure 700 for synchronization with the SSB-less SCell 504. The procedure 700 may be similar to the procedure 500 and the procedure 600 with the addition of additional beam sweeping. For example, additional beam sweeping may allow the UE 120 to adjust a receive beam. In some implementations, transmit beam sweeping may be used to change a transmit beam 702 for the SCell 504 (e.g., to be different than the beam 704). The beam sweeping may be limited by the angle δ for faster beam acquisition.

In an aspect, the SCell 504 may transmit a CSI-RS 706 for beam acquisition. In some implementations, the CSI-RS 706 may include a first burst 708 on different beams and a second burst 710 on the same beam. The first burst 708 may be used for P2 beam sweeping (beam sweeping for a P3 beam management process) of the transmit beam. That is, the SCell 504 may sweep the first burst 708 around the beam 704 for the PCell 502 (e.g., by transmitting on beams within the angle δ of the beam 704). The UE 120 may perform a P2 beam sweep 712 by selecting a beam based on the first burst 708. The UE 120 may indicate the selected beam, for example, by transmitting a MAC-CE 714.

In an aspect, the SCell 504 may transmit the second burst 710 on the same beam. The UE 120 may perform a P3 beam sweep 716 (beam sweep for a P3 beam management procedure) by receiving each beam of the second burst 710 with a different receive beam. In an aspect, the receive beams may be within a range [θ-δ, θ+δ]. The number NZP-CSI-RS resources for the second burst 710 may be based on the angle δ. The UE 120 may select the best receive beam for the SCell 504.

In some implementations, the UE 120 may have a single Rx chain. In such cases, the UE 120 may not be able to measure the PCell 502 when tuned to the SCell 504. The UE 120 may be configured with CSI-RS measurements (e.g., layer 3 measurement objects) for mobility. Accordingly, the UE 120 may measure a CSI-RS 706 from the SCell 504 for mobility purposes without switching back to the PCell 502. In cases where the UE 120 does switch back to the PCell 502 (e.g., to measure the SSB 506), the UE 120 may perform the P2 beam sweep 712 and/or the P3 beam sweep 716 upon returning to the SCell 504.

As indicated above, FIG. 7 is provided as an example. Other examples may differ from what is described with regard to FIG. 7.

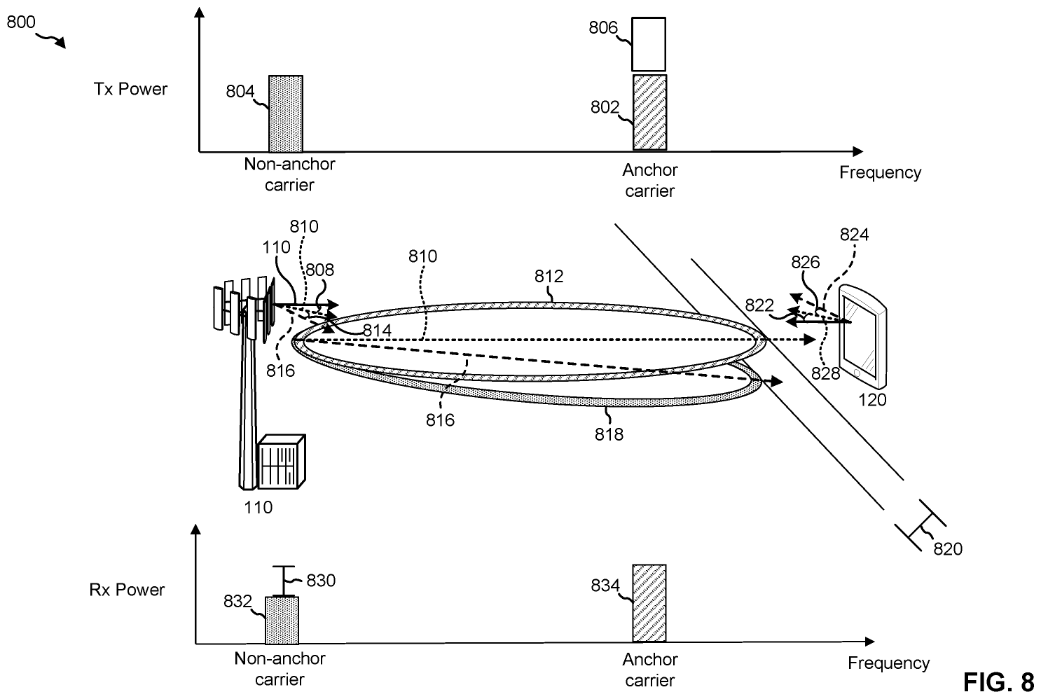

FIG. 8 is a diagram 800 illustrating an example of beam squinting in inter-band carrier aggregation. As shown, a UE 120 and a network node 110 may communicate with one another. The network node 110 may transmit signals via an anchor carrier and a non-anchor carrier. For example, the network node 110 may include a first TRP associated with the anchor carrier and a second TRP associated with the non-anchor carrier. In other examples, the network node 110 may include one TRP that transmits signals in both carriers. In carrier aggregation, the network node 110 may transmit a signal via the anchor carrier (e.g., via a PCell) with a same transmission power 802 as the transmission power 804 for the non-anchor carrier (e.g., an SCell). The network node 110 may also transmit an SSB 806 via the anchor carrier. By foregoing transmission of an SSB via the non-anchor carrier, the network node 110 may conserve power. The lack of SSB on the non-anchor carrier, however, implies that beam management for the non-anchor carrier is based on the SSB 806 (or other RS such as CSI-RS) of the anchor carrier. That is, the carrier aggregation uses common beam management (CBM) for the anchor carrier and the non-anchor carrier.

In an aspect, beam squinting occurs due to a first AoD 808 associated with a transmission direction (which may be referred to as a beam direction) 810 of a first network transmit beam 812 corresponding to the anchor carrier diverging from a second AoD 814 associated with a transmission direction 816 of a second network transmit beam 818 corresponding to the non-anchor carrier. The divergence between the two AoDs 808 and 814 may be referred to as an angle of divergence. Although the AoD 810 and AoD 814 are conceptually represented in FIG. 8 as two-dimensional angles between the respective beam directions 810 and 816, in implementations, the AoDs 810 and 814 may be three-dimensional angles as described above in FIG. 4B. That is, the network node 110 transmits the network transmit beam 812 via the anchor carrier using the beam selected based on the SSB 806. The network transmit beam 812 may be updated as needed based on periodic transmission of the SSB 806. The network node 110 transmits a network transmit beam 818 via the non-anchor carrier.

Because there is no SSB transmitted on the frequency of the non-anchor carrier, however, the network transmit beam 812 may deviate from the network transmit beam 816, for example, due to different channel conditions at the different frequencies. The different network transmit beams 812 and 816 may result in a difference 820 in antenna gain at the UE 120. The difference 820 in antenna gain at the UE 120 is shown in FIG. 8, conceptually, as a difference in distance from the network node 110 that the respective beams 812 and 818 reach, since the antenna gain is a function of distance and two beams with divergent AoDs also will have divergent AoAs at the UE. For example, as shown, the UE 120 may receive a transmission via the network transmit beam 812 at a first AoA 822 associated with a reception direction 824 associated with the network transmit beam 812, and may receive a transmission via the network transmit beam 818 at a second AoA 826 associated with a reception direction 826 associated with the network transmit beam 818. Although the AoA 822 and AoA 826 are conceptually represented in FIG. 8 as two-dimensional angles between the respective reception directions 824 and 828, in implementations, the AoAs 822 and 826 may be three-dimensional angles as described above in FIG. 4B. In some cases, the network transmit beam 818 may experience lower antenna gain at the UE 120 than the network transmit beam 812 due to the difference in AoAs, which results in a difference in a distance between the UE 120 and the respective transmitting antenna elements along a direction that is normal to the respective transmitting antenna elements. At the UE 120, the difference 820 in antenna gain results in a difference 830 between a received power 832 associated with the non-anchor carrier and a received power 834 associated with the anchor carrier. The difference 808 may reduce the feasibility of inter-band CA for SSB-less cells as the result of the UE 120 receiving transmissions via a beam corresponding to the non-anchor carrier that has less power than a beam corresponding to the anchor carrier, potentially resulting in lower signal-to-noise-plus-interference (SINR) signals, lower RSRPs, and/or other indicators of a lower channel quality.

As explained above, the network can assist the UE to perform limited range P3 beam sweeping, under the assumption that the transmitted beam (e.g., TCI state) is the same in the anchor carrier and the non-anchor carrier. However, in a case of beam squinting, as described above, the TCI state corresponding to the transmitted beam may not be the same in the anchor and non-anchor carriers, and thus, a P2 beam management procedure may result in acquisition of a beam associated with a non-anchor carrier that may not be suitable for communications therewith. For example, if beam squinting is such that the transmitted beam at the non-anchor carrier is diverged by a large angle from the transmitted beam at the anchor carrier, the propagation multipath profile (e.g., a set of multipath propagation characteristics associated with a time (e.g., delay characteristics), frequency (e.g., phase characteristics), and/or spatial (e.g., angle characteristics) domain will be different in the anchor carrier compared to the propagation multipath profile in the non-anchor carrier as a consequence of the resulting differences in angle of arrival at the UE, differences in distance in the UE, and/or differences in physical paths (and/or obstacles therein) traversed by signals via the different carriers. Thus, the limited range P3 beam sweeping may be confined to an angle range that excludes a better network transmit beam.

Some aspects of the techniques and apparatuses described herein may provide for acquisition of a suitable non-anchor carrier network transmit beam based on an anchor carrier network transmit beam. For example, in some aspects, a network node may determine, based on a beam metric, whether a beam (e.g., TCI state) associated with the anchor carrier is suitable for use with the non-anchor carrier. In aspects in which the beam is unsuitable, the network node may perform a network transmit beam refinement procedure (e.g., a limited range P2 beam sweeping) to facilitate acquisition of a suitable beam associated with the non-anchor carrier. The network node may provide an indication to the UE as to whether the network transmit beam refinement procedure is to be performed. In this way, some aspects may therefor result in faster beam acquisition in the non-anchor carrier, leading to lower UE power consumption and network energy savings, thereby positively impacting network performance.

As indicated above, FIG. 8 is provided as an example. Other examples may differ from what is described with regard to FIG. 8.

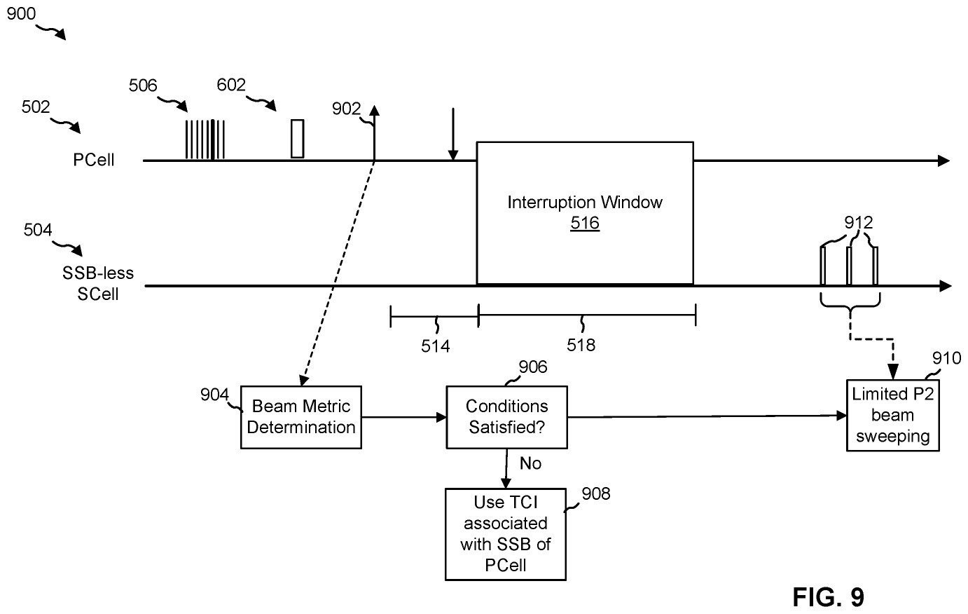

FIG. 9 is a diagram of an example 900 associated with beam management for non-anchor carriers, in accordance with the present disclosure. As shown by reference number 902, a network node associated with the Pcell 502 and the SSB-less cell 504 may receive, from the UE, a measurement report associated with one or more reference signals (e.g., the SSB 506 and/or the CSI-RS 602). The measurement report may include a layer 1 RSRP (L1-RSRP) report that indicates an RSRP measurement associated with the reference signals (or a set of RSRP measurements associated with the reference signals).

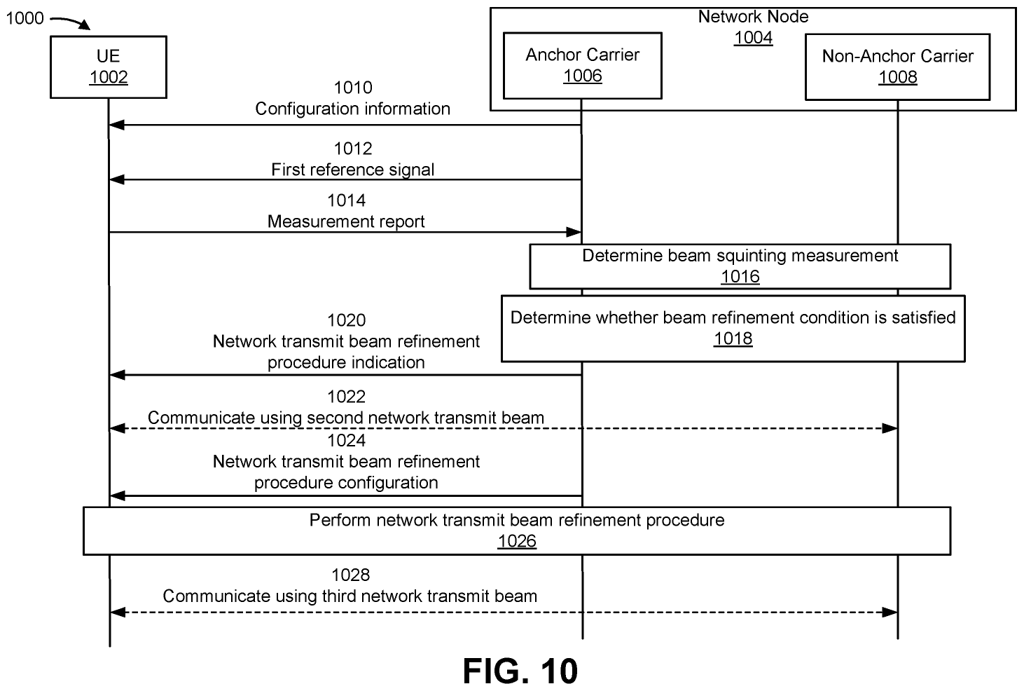

As shown by reference number 904, the network node may determine a beam metric based on the measurement report. As shown by reference number 906, the network node may determine whether the beam metric satisfies one or more conditions. If the one or more conditions are not satisfied, as shown by reference number 908, the TCI associated with the SSB 506 of the PCell may be used for a transmission beam on the SSB-less cell 504. If the one or more conditions are satisfied, as shown by reference number 910, the network node may perform a limited P2 beam sweeping operation based on transmitted CSI-RSs 912 swept over a limit set of network transmit beams, as described below in connection with FIG. 10.

As indicated above, FIG. 9 is provided as an example. Other examples may differ from what is described with regard to FIG. 9.

FIG. 10 is a call flow diagram of an example 1000 associated with beam management for non-anchor carriers, in accordance with the present disclosure. As shown in FIG. 10, a UE 1002 and a network node 1004 may communicate with one another. As shown, the network node 1004 may communicate using an anchor carrier 1006 and a non-anchor carrier 1008. In some cases, the UE 1002 may be, be similar to, include, or be included in, the UE 120 depicted in FIGS. 1-5. In some cases, the network node 1004 may be, be similar to, include, or be included in, the network node 110 depicted in FIGS. 1, 2, 4, and 5, and/or the disaggregated base station architecture 300 depicted in FIG. 3. In some cases, the anchor carrier 1006 may be, be similar to, include, or be included in, the Pcell 502 depicted in FIGS. 6-8. In some cases, the non-anchor carrier 1008 may be, be similar to, include, or be included in, the SSB-less cell 504 depicted in FIGS. 6-8.

As shown by reference number 1010, the network node 1004 (using the anchor carrier 1006) may transmit, and the UE 1002 may receive, configuration information. In some aspects, the configuration information may include a measurement reporting configuration associated with a first reference signal (or a first set of reference signals). For example, the configuration information may configure a P1 beam management procedure. In some aspects, the first reference signal and/or first set of reference signals may include an SSB and/or SSBs, respectively. In some other aspects, the first reference signal and/or first set of reference signals may include a CSI-RS and/or CSI-RSs, respectively. For example, in some aspects, the configuration information may include a CSI report configuration that configures the UE 1002 with a CSI reporting procedure and/or a CSI report. In some aspects, the configuration information may include a plurality of CSI report configurations, each CSI report configuration corresponding to at least one of a CSI-RS resource, a repetition of the CSI-RS resource, or a quantity of repetitions of the CSI-RS resource.

As shown by reference number 1012, the network node 1004 (via the anchor carrier 1006) may transmit, and the UE 1002 may receive, the first reference signal. In some aspects, the network node 1004 may transmit a first set of reference signals that includes the first reference signal. The network node 1004 may transmit the first reference signal using a first network transmit beam corresponding to the anchor carrier 1006. As shown by reference number 1014, the UE 1002 may transmit, and the network node 1004 may receive (via the anchor carrier 1006), a measurement report. The measurement report may be associated with the first reference signal and may be transmitted based on the configuration information. The measurement report may include a layer 1 RSRP (L1-RSRP) report that indicates an RSRP measurement associated with the first reference signal (or a set of RSRP measurements associated with the first set of reference signals).

As shown by reference number 1016, the network node 1004 may determine a beam squinting measurement. The beam squinting measurement may be associated with the with the first network transmit beam and a second network transmit beam corresponding to the non-anchor carrier 1008. In some aspects, the beam squinting measurement may be determined based on a first angle of departure (AoD) associated with the first network transmit beam and a second AoD associated with the second network transmit beam. For example, the beam squinting measurement, AaoD, may include an angle divergence value equal to a difference between a first AoD associated with the first network transmit beam and a second AoD associated with the second network transmit beam. In some aspects, the beam squinting measurement, ΔaoD, may be determined according to

$$Δ AOD = arc sin ( \frac{f 0}{f} sin {θ}_{0} ) - {θ}_{0} ,$$

where f0 is the frequency associated with the anchor carrier, f is the frequency associated with the non-anchor carrier, and θ₀ is the beam angle associated with the first network transmit beam.

As shown by reference number 1018, the network node 1004 may determine whether one or more beam refinement conditions are satisfied (e.g., whether one or more beam refinement conditions are met and/or whether one or more beam refinement conditions are present). For example, the network node 1004 may determine whether the one or more beam refinement conditions are satisfied to determine whether a network transmit beam refinement procedure should be performed. In some aspects, for example, if the one or more beam refinement conditions are not satisfied, the same TCI state can be used for both the anchor carrier and non-anchor carrier. However, if the one or more beam refinement conditions are satisfied, a limited range network transmit beam refinement procedure (e.g., a P2 beam management procedure) may be performed so that a suitable network transmit beam associated with the non-anchor carrier 1008 may be identified. If the one or more beam refinement conditions are not satisfied (e.g., if the one or more beam refinement conditions fail to be satisfied, the one or more beam refinement conditions are not met, and/or the one or more beam refinement conditions are not present), the network node 1004 may indicate that the network transmit beam refinement procedure is not to be performed.

In some aspects, the one or more beam refinement conditions may include a beam squinting condition. A beam squinting condition may be a condition (e.g., a threshold) associated with a beam squinting measurement. For example, in some aspects, the network node 1004 may determine whether a beam squinting measurement satisfies a beam squinting condition. In some aspects, for example, a beam squinting measurement may satisfy the beam squinting condition based on the angle divergence value being greater than a beam width of the first network transmit beam. On the contrary, the beam squinting measurement may fail to satisfy the beam squinting condition (e.g., the beam squinting measurement may not satisfy the beam squinting condition, the beam squinting measurement may not meet the beam squinting condition, and/or the beam squinting condition may not be present) based on the angle divergence value being less than or equal to the beam width of the first network transmit beam. For example, if the angle divergence, ΔaoD, is smaller than the beam width, the same TCI state can be used for both the anchor carrier and non-anchor carrier.

In some aspects, the network node 1004 may determine whether a frequency condition is satisfied. The frequency condition may be satisfied based on a frequency difference between a first frequency associated with the anchor carrier and a second frequency associated with the non-anchor carrier satisfying a frequency difference threshold. In some aspects, the network node 1004 may determine that the frequency condition is not satisfied (e.g., the frequency condition may fail to be satisfied the frequency condition may not be met, and/or the frequency condition may not be present). In some aspects, the network node 1004 may determine whether a beam direction condition is satisfied. For example, the beam direction condition may be satisfied based on a beam divergence angle between a transmission direction associated with the second network transmit beam and a boresight direction associated with an antenna element from which the second network transmit beam is transmitted satisfying a beam divergence threshold. In some aspects, the network node 1004 may determine that the beam direction condition is not satisfied (e.g., the beam direction condition may fail to be satisfied the beam direction condition may not be met, and/or the beam direction condition may not be present). In some aspects, the network node 1004 may determine whether a beam width condition is satisfied. For example, the beam width condition may be satisfied based on a beam width of the second network transmit beam satisfying a beam width threshold. In some aspects, the network node 1004 may determine that the beam width condition is not satisfied (e.g., the beam width condition may fail to be satisfied the beam width condition may not be met, and/or the beam width condition may not be present).

In some aspects, the network node 1004 may determine whether a network transmit beam refinement procedure is to be performed based on any number of different combinations of the conditions described above. For example, a determination of whether the beam squinting effect at the network node 1004 is such that a P2 beam sweeping should be performed may be a factor of frequency difference between carriers, an angle between a direction associated with an edge of a transmitted network transmit beam and the boresight of the transmitted beam (referred to as an “angle to boresight”), and/or a transmitted beam width, among other examples.

For example, in a cell (e.g., carrier) with 32 SSB beams, the network node 1004 of a given cell may cover 120°, which means that a single SSB beam has a beam width equal to 3.75°. In some cases, the angle to boresight may be equal to 45°. Thus, for a carrier frequency distance equal to 1 GHz (e.g., 24.25 GHz and 25.25 GHz), the beam angle separation may be 2.23°, which means that the beam at the non-anchor cell 1008 is within an SSB beam of the anchor cell. In other words, the transmitted beam at the non-anchor carrier 1008 is very similar to the transmitted beam at the anchor carrier 1006 and, accordingly, the network node 1004 may determine that the multipath propagation delay profile associated with the non-anchor carrier 1008 is likely to be similar to the multipath propagation delay profile of the anchor carrier 1006. Thus, the network node 1004 may determine that the same TCI state may be used in both carriers 1006 and 1008 and that a P2 beam management procedure is unnecessary.

In some other aspects, for a carrier frequency distance equal to 5.25 GHz (e.g., the distance between a carrier frequency of 24.25 GHz and a carrier frequency of 29.5 GHz), the beam angle separation is 9.46°, which means that the beam associated with the non-anchor carrier 1008 is not within the same beam (e.g., TCI state) as the beam associated with the anchor carrier 1006. Accordingly, the network node 1004 may determine that a multipath propagation profile associated with the transmitted beam associated with the non-anchor carrier 1008 is different from the multipath propagation profile associated with the transmitted beam associated with the anchor carrier 1006. Thus, the network node 1004 may determine that a P2 beam management procedure should be performed.

As shown by reference number 1020, the network node 1004, via the anchor carrier 1006, may transmit, and the UE 1002 may receive, a network transmit beam refinement procedure indication. The network transmit beam refinement procedure indication may indicate whether a network transmit beam refinement procedure is to be performed. In some aspects, the network node 1004 may transmit the network transmit beam refinement procedure indication based on the measurement report. For example, the network node 1004 may transmit the network transmit beam refinement procedure indication based on receiving the measurement report and determining whether the one or more conditions are satisfied. The network transmit beam refinement procedure indication may indicate whether the network transmit beam refinement procedure is to be performed.

For example, in some aspects, the network transmit beam refinement procedure indication may indicate, based on the beam squinting measurement failing to satisfy a beam squinting condition, that the network transmit beam refinement procedure is not to be performed. In some other aspects, the network transmit beam refinement procedure indication may indicate, based on the beam squinting measurement satisfying a beam squinting condition, that the network transmit beam refinement procedure is to be performed. In some aspects, the network transmit beam refinement procedure indication may indicate, further based on a frequency condition being satisfied, that the network transmit beam refinement procedure is to be performed. In some aspects, the network transmit beam refinement procedure indication may indicate, further based on a beam direction condition being satisfied, that the network transmit beam refinement procedure is to be performed. In some aspects, the network transmit beam refinement procedure indication may indicate, further based on a beam width condition being satisfied, that the network transmit beam refinement procedure is to be performed.

As shown by reference number 1022, the UE 1002 may communicate with the network node 1004 via the non-anchor carrier 1008 using the second network transmit beam (e.g., the network transmit beam, associated with the non-anchor carrier, that was acquired during the P1 beam management procedure). For example, a first TCI state associated with the first network transmit beam may be equal to a second TCI state associated with the second network transmit beam (e.g., the second network transmit beam may be associated with a same TCI state that is associated with the first network transmit beam). In some aspects, the UE 1002 may communicate with the network node 1004 via the non-anchor carrier 1008 using the second network transmit beam based on the network transmit beam refinement procedure indication indicating that the network transmit beam refinement procedure is not to be performed.

In aspects in which the network transmit beam refinement procedure indication indicates that the network transmit beam refinement procedure is to be performed, however, the network node 1004 may configure the UE 1002 for performing the network transmit beam refinement procedure.

As shown by reference number 1024, the network node 1004, using the anchor carrier 1006, may transmit, and the UE 1002 may receive, a network transmit beam refinement procedure configuration. The network transmit beam refinement procedure configuration may be associated with the network transmit beam refinement procedure. In some aspects, the network transmit beam refinement procedure configuration may include configuration information associated with a beam sweeping operation (e.g., a limited range P2 beam sweeping operation).

In some aspects, the network transmit beam refinement procedure configuration may indicate a set of network transmit beams associated with the non-anchor carrier over which the beam sweeping operation is to be performed. In some aspects, the set of network transmit beams may be based on the angle divergence value associated with the first network transmit beam and the second network transmit beam. For example, if the beam angle deviation is equal 9.46°, which corresponds to ceil[9.46°/3.75°]=3 beams (of 3.75° beam width), and assuming a margin of one more beam, then the limited range P2 beam sweeping may take place within 4 (3+1) beams, which are the 4 beams with the strongest L1-RSRP associated with the non-anchor carrier 1008. In some aspects, the strongest beam associated with the non-anchor carrier 1008 be determined based on a mapping function that maps a set of signal measurements associated with the anchor carrier to the set of network transmit beams. For example, the mapping function may map the K best RSRPs associated with the anchor carrier 1006 to a set of K best network transmit beams associated with the non-anchor carrier 1008.

The network transmit beam refinement procedure configuration also may indicate an order of network transmit beams associated with the non-anchor carrier to be swept associated with the beam sweeping operation. For example, in some aspects, the order of the beams swept at the non-anchor carrier 1008 may be random. In some aspects, the order of the beams may be based on the beam number. For example, if the 6 strongest network transmit beams (e.g., TCI states) associated with the anchor carrier 1006 are TCI State #23, TCI State #14, TCI State #34, TCI State #4, TCI State #7, and TCI State #12, then the beam sweeping associated with the non-anchor carrier 1008 may be performed in the following order: TCI State #4, TCI State #7, TCI State #12, TCI State #14, TCI State #23, and TCI State #34.

In some aspects, the network transmit beam refinement procedure configuration may indicate a quantity, K, of network transmit beams associated with the non-anchor carrier over which the beam sweeping operation is to be performed. The network transmit beam refinement procedure configuration also may indicate a beam rule associated with an order of network transmit beams associated with the non-anchor carrier to be swept associated with the beam sweeping operation. For example, the order with which the beams are swept may correspond to a descending order of signal strength associated with the beams. For example, the first beam swept at the non-anchor carrier 1008 may be the beam with the strongest L1-RSRP in the anchor carrier 1006, the second beam swept at the non-anchor carrier may be the beam with the second strongest L1-RSRP in the anchor carrier 1006, and so on.

As shown by reference number 1026, the UE 1002 and the network node 1004, using the non-anchor carrier 1008, may perform the network transmit beam refinement procedure. As shown by reference number 1028, the UE 1002 and the network node 1004 may communicate using a third network transmit beam (e.g., a network transmit beam identified during the network transmit beam refinement procedure). In some aspects, the network node 1004 may perform the network transmit beam refinement procedure by performing the limited range beam sweeping operation. The limited range beam sweeping operation may be performed by transmitting a set of reference signals. In some aspects, the set of reference signals may include CSI-RSs. Each reference signal of the set of reference signals may be associated with a respective network transmit beam of a set of network transmit beams associated with the non-anchor carrier 1008. In some aspects, the network node 1004 may transmit the set of reference signals according to a descending order of signal strength associated with the set of network transmit beams. In some aspects, the network node 1004 may transmit the set of reference signals according to a random order of network transmit beams of the set of network transmit beams. In some aspects, the network node 1004 may transmit the set of reference signals according to a configured order of network transmit beam identifiers associated with the set of network transmit beams.

In some aspects, the network node 1004 may transmit a beam indication to indicate a beam switch on the non-anchor carrier 1008. For example, the network node 1004 may perform the beam sweeping operation by transmitting a first reference signal using a first network transmit beam of a set of network transmit beams associated with the non-anchor carrier 1008, transmitting a beam switch indication associated with switching from the first network transmit beam to a second network transmit beam, and then transmitting a second reference signal using the second network transmit beam. In this way, the UE 1002 may be alerted to reset loop filtering to facilitate reception of the second network transmit beam.

As indicated above, FIG. 10 is provided as an example. Other examples may differ from what is described with regard to FIG. 10.

FIG. 11 is a diagram illustrating an example process 1100 performed, for example, by a network node, in accordance with the present disclosure. Example process 1100 is an example where the network node (e.g., network node 1004) performs operations associated with beam management for non-anchor carriers.

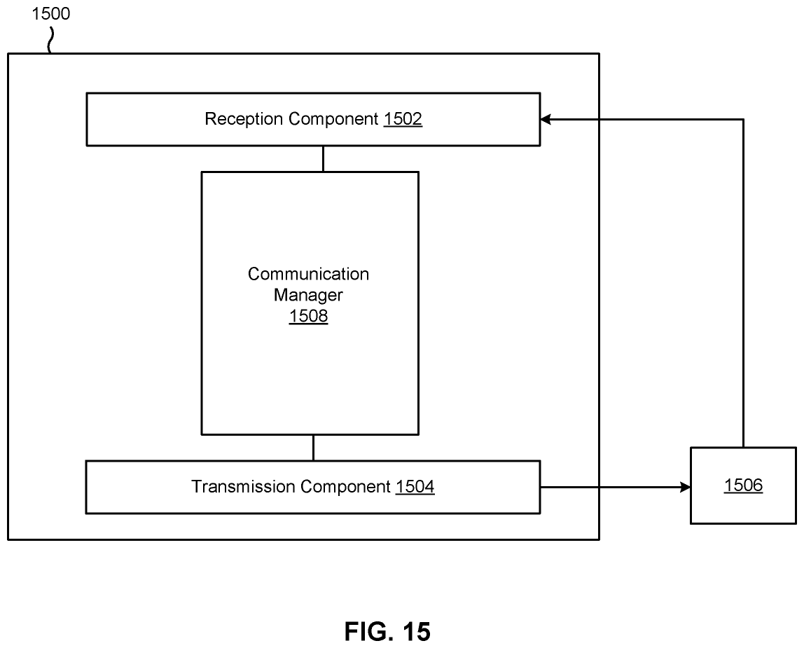

As shown in FIG. 11, in some aspects, process 1100 may include transmitting a first reference signal using a first network transmit beam corresponding to a first carrier (block 1110). For example, the network node (e.g., using communication manager 1508 and/or transmission component 1504, depicted in FIG. 15) may transmit a first reference signal using a first network transmit beam corresponding to a first carrier, as described above.

As further shown in FIG. 11, in some aspects, process 1100 may include transmitting, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier (block 1120). For example, the network node (e.g., using communication manager 1508 and/or transmission component 1504, depicted in FIG. 15) may transmit, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier, as described above.

Process 1100 may include additional aspects, such as any single aspect or any combination of aspects described below and/or in connection with one or more other processes described elsewhere herein.

In a first aspect, process 1100 includes communicating using the second network transmit beam, wherein a first transmission configuration indicator (TCI) state associated with the first network transmit beam is equal to a second TCI state associated with the second network transmit beam. In a second aspect, alone or in combination with the first aspect, the beam metric comprises an angle divergence value equal to a difference between a first AoD associated with the first network transmit beam and a second AoD associated with the second network transmit beam. In a third aspect, alone or in combination with the second aspect, the beam metric failing to satisfy the beam refinement condition is based on the angle divergence value being less than a beam width of a reference network transmit beam corresponding to the second carrier. In a fourth aspect, alone or in combination with the third aspect, the reference network transmit beam comprises a network transmit beam associated with a relative power that is greater than or equal to a product of a peak power and an indicated multiplier.

In a fifth aspect, alone or in combination with one or more of the first through fourth aspects, the beam metric failing to satisfy the beam refinement condition is further based on a frequency condition failing to be satisfied. In a sixth aspect, alone or in combination with the fifth aspect, the frequency condition failing to be satisfied is based on a frequency difference between a first frequency associated with the first carrier and a second frequency associated with the second carrier failing to satisfy a frequency difference threshold.

In a seventh aspect, alone or in combination with one or more of the first through sixth aspects, the beam metric failing to satisfy the beam refinement condition is further based on a beam direction condition failing to be satisfied. In an eighth aspect, alone or in combination with the seventh aspect, the beam direction condition failing to be satisfied is based on a beam deviation failing to satisfy a beam deviation threshold, the beam deviation comprising an angle between a transmission direction associated with the second network transmit beam and a boresight direction associated with an antenna element from which the second network transmit beam is transmitted.

In a ninth aspect, alone or in combination with one or more of the first through eighth aspects, the beam metric failing to satisfy the beam refinement condition is further based on a beam width condition failing to be satisfied. In a tenth aspect, alone or in combination with the ninth aspect, the beam width condition failing to be satisfied is based on a beam width of a reference network transmit beam, corresponding to the second carrier, failing to satisfy a beam width threshold. In an eleventh aspect, alone or in combination with the tenth aspect, the reference network transmit beam comprises a network transmit beam associated with a relative power that is greater than or equal to a product of a peak power and an indicated multiplier.

In a twelfth aspect, alone or in combination with one or more of the first through eleventh aspects, process 1100 includes transmitting configuration information indicating a measurement reporting configuration associated with the first network transmit beam, and receiving a measurement report associated with the first network transmit beam, wherein transmitting the network transmit beam refinement procedure communication comprises transmitting the network transmit beam refinement procedure communication based on receiving the measurement report. In a thirteenth aspect, alone or in combination with one or more of the first through twelfth aspects, the first carrier comprises an anchor carrier and the second carrier comprises a non-anchor carrier. In a fourteenth aspect, alone or in combination the thirteenth aspect, the non-anchor carrier comprises a synchronization signal block-less carrier. In a fifteenth aspect, alone or in combination with one or more of the first through fourteenth aspects, the first reference signal comprises at least one of a synchronization signal block or a channel state information reference signal.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 1004) performs operations associated with beam management for non-anchor carriers.

As shown in FIG. 12, in some aspects, process 1200 may include transmitting a first reference signal using a first network transmit beam corresponding to a first carrier (block 1210). For example, the network node (e.g., using communication manager 1508 and/or transmission component 1504, depicted in FIG. 15) may transmit a first reference signal using a first network transmit beam corresponding to a first carrier, as described above.

As further shown in FIG. 12, in some aspects, process 1200 may include transmitting, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier (block 1220). For example, the network node (e.g., using communication manager 1508 and/or transmission component 1504, depicted in FIG. 15) may transmit, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier, as described above.

Process 1200 may include additional aspects, such as any single aspect or any combination of aspects described below and/or in connection with one or more other processes described elsewhere herein.

In a first aspect, the beam metric comprises an angle divergence value equal to a difference between a first AoD associated with the first network transmit beam and a second AoD associated with the second network transmit beam. In a second aspect, alone or in combination with the first aspect, the beam metric satisfying the beam refinement condition is based on the angle divergence value being greater than or equal to a beam width of a reference network transmit beam corresponding to the second carrier. In a third aspect, alone or in combination with the second aspect, the reference network transmit beam comprises a network transmit beam associated with a relative power that is greater than or equal to a product of a peak power and an indicated multiplier.

In a fourth aspect, alone or in combination with one or more of the first through third aspects, the beam metric satisfying the beam refinement condition is further based on a frequency condition being satisfied. In a fifth aspect, alone or in combination with the fourth aspect, the frequency condition being satisfied is based on a frequency difference between a first frequency associated with the first carrier and a second frequency associated with the second carrier satisfying a frequency difference threshold.

In a sixth aspect, alone or in combination with one or more of the first through fifth aspects, the beam metric satisfying the beam refinement condition is further based on a beam direction condition being satisfied. In a seventh aspect, alone or in combination with the sixth aspect, the beam direction condition being satisfied is based on a beam deviation satisfying a beam deviation threshold, the beam deviation comprising an angle between a transmission direction associated with the second network transmit beam and a boresight direction associated with an antenna element from which the second network transmit beam is transmitted.

In an eighth aspect, alone or in combination with one or more of the first through seventh aspects, the beam metric satisfying the beam refinement condition is further based on a beam width condition being satisfied. In a ninth aspect, alone or in combination with the eighth aspect, the beam width condition being satisfied is based on a beam width of a reference network transmit beam, corresponding to the second carrier, satisfying a beam width threshold. In a tenth aspect, alone or in combination with the ninth aspect, the reference network transmit beam comprises a network transmit beam associated with a relative power is greater than or equal to a product of a peak power and an indicated multiplier.

In an eleventh aspect, alone or in combination with one or more of the first through tenth aspects, process 1200 includes transmitting configuration information indicating a measurement reporting configuration associated with the first network transmit beam, and receiving a measurement report associated with the first network transmit beam, wherein transmitting the network transmit beam refinement procedure communication comprises transmitting the network transmit beam refinement procedure communication based on receiving the measurement report.

In a twelfth aspect, alone or in combination with one or more of the first through eleventh aspects, process 1200 includes transmitting a network transmit beam refinement procedure configuration associated with the network transmit beam refinement procedure, the network transmit beam refinement procedure configuration comprising configuration information associated with a beam sweeping operation. In a thirteenth aspect, alone or in combination with the twelfth aspect, the network transmit beam refinement procedure configuration indicates a plurality of candidate network transmit beams, corresponding to the second carrier, associated with the beam sweeping operation. In a fourteenth aspect, alone or in combination with the thirteenth aspect, the network transmit beam refinement procedure configuration indicates a quantity of candidate network transmit beams of a plurality of candidate network transmit beams, corresponding to the second carrier, associated with the beam sweeping operation. In a fifteenth aspect, alone or in combination with one or more of the first through fourteenth aspects, the network transmit beam refinement procedure configuration indicates a sweeping order associated with a plurality of candidate network transmit beams, corresponding to the second carrier, associated with the beam sweeping operation.

In a sixteenth aspect, alone or in combination with one or more of the first through fifteenth aspects, process 1200 includes performing the beam sweeping operation. In a seventeenth aspect, alone or in combination with the sixteenth aspect, performing the beam sweeping operation comprises transmitting a plurality of reference signals, wherein each reference signal of the plurality of reference signals is associated with a respective candidate network transmit beam of a plurality of candidate network transmit beams corresponding to the second carrier. In an eighteenth aspect, alone or in combination with the sixteenth aspect, transmitting the plurality of reference signals comprises transmitting the plurality of reference signals according to a descending order of signal strength associated with the plurality of candidate network transmit beams. In a nineteenth aspect, alone or in combination with the sixteenth aspect, transmitting the plurality of reference signals comprises transmitting the plurality of reference signals according to a random order of candidate network transmit beams of the plurality of candidate network transmit beams. In a twentieth aspect, alone or in combination with the sixteenth aspect, transmitting the plurality of reference signals comprises transmitting the plurality of reference signals according to a configured order of network transmit beam identifiers associated with the plurality of candidate network transmit beams.

In a twenty-first aspect, alone or in combination with one or more of the sixteenth through twentieth aspects, the plurality of candidate network transmit beams is based on an angle divergence value equal to a difference between a first AoD associated with the first network transmit beam and a second AoD associated with the second network transmit beam. In a twenty-second aspect, alone or in combination with one or more of the sixteenth through twenty-first aspects, the plurality of candidate network transmit beams is based on a mapping function that maps a set of signal measurements associated with the first carrier to the plurality of candidate network transmit beams.

In a twenty-third aspect, alone or in combination with one or more of the fifteenth through twenty-second aspects, performing the beam sweeping operation comprises transmitting a first beam refinement reference signal using a first candidate network transmit beam of a plurality of candidate network transmit beams corresponding to the second carrier, transmitting a beam switch indication associated with switching from the first candidate network transmit beam to a second candidate network transmit beam, and transmitting a second beam refinement reference signal using the second candidate network transmit beam.

In a twenty-fourth aspect, alone or in combination with one or more of the first through twenty-third aspects, the first carrier is an anchor carrier and the second carrier is a non-anchor carrier. In a twenty-fifth aspect, alone or in combination with the twenty-fourth aspect, the non-anchor carrier comprises a synchronization signal block-less carrier. In a twenty-sixth aspect, alone or in combination with one or more of the first through twenty-fifth aspects, the first reference signal comprises at least one of a synchronization signal block or a channel state information reference signal.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 1002) performs operations associated with beam management for non-anchor carriers.

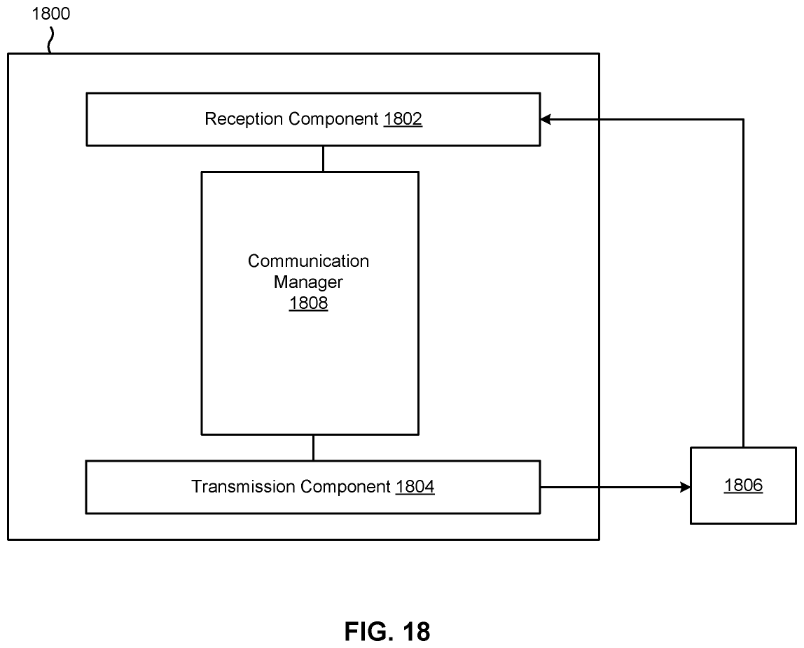

As shown in FIG. 13, in some aspects, process 1300 may include receiving a first reference signal using a first network transmit beam corresponding to a first carrier (block 1310). For example, the UE (e.g., using communication manager 1808 and/or reception component 1802, depicted in FIG. 18) may receive a first reference signal using a first network transmit beam corresponding to a first carrier, as described above.

As further shown in FIG. 13, in some aspects, process 1300 may include receiving, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier (block 1320). For example, the UE (e.g., using communication manager 1808 and/or reception component 1802, depicted in FIG. 18) may receive, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier, as described above.

Process 1300 may include additional aspects, such as any single aspect or any combination of aspects described below and/or in connection with one or more other processes described elsewhere herein.

In a first aspect, process 1300 includes communicating using the second network transmit beam, wherein a first TCI state associated with the first network transmit beam is equal to a second TCI state associated with the second network transmit beam. In a second aspect, alone or in combination with the first aspect, the beam metric comprises an angle divergence value equal to a difference between a first angle of departure (AoD) associated with the first network transmit beam and a second AoD associated with the second network transmit beam. In a third aspect, alone or in combination with the second aspect, the beam metric failing to satisfy the beam refinement condition is based on the angle divergence value being less than a beam width of a reference network transmit beam corresponding to the second carrier. In a fourth aspect, alone or in combination with the third aspect, the reference network transmit beam comprises a network transmit beam associated with a relative power that is greater than or equal to a product of a peak power and an indicated multiplier.

In a fifth aspect, alone or in combination with one or more of the first through fourth aspects, the beam metric failing to satisfy the beam refinement condition is further based on a frequency condition failing to be satisfied. In a sixth aspect, alone or in combination with the fifth aspect, the frequency condition failing to be satisfied is based on a frequency difference between a first frequency associated with the first carrier and a second frequency associated with the second carrier failing to satisfy a frequency difference threshold. In a seventh aspect, alone or in combination with one or more of the first through sixth aspects, the beam metric failing to satisfy the beam refinement condition is further based on a beam direction condition failing to be satisfied. In an eighth aspect, alone or in combination with the seventh aspect, the beam direction condition failing to be satisfied is based on a beam deviation failing to satisfy a beam deviation threshold, the beam deviation comprising an angle between a transmission direction associated with the second network transmit beam and a boresight direction associated with an antenna element from which the second network transmit beam is transmitted.

In a ninth aspect, alone or in combination with one or more of the first through eighth aspects, the beam metric failing to satisfy the beam refinement condition is further based on a beam width condition failing to be satisfied. In a tenth aspect, alone or in combination with the ninth aspect, the beam width condition failing to be satisfied is based on a beam width of a reference network transmit beam, corresponding to the second carrier, failing to satisfy a beam width threshold. In an eleventh aspect, alone or in combination with the tenth aspect, the reference network transmit beam comprises a network transmit beam associated with a relative power that is greater than or equal to a product of a peak power and an indicated multiplier.

In a twelfth aspect, alone or in combination with one or more of the first through eleventh aspects, process 1300 includes receiving configuration information indicating a measurement reporting configuration associated with the first network transmit beam, and transmitting a measurement report associated with the first network transmit beam, wherein receiving the network transmit beam refinement procedure communication comprises receiving the network transmit beam refinement procedure communication based on receiving the measurement report. In a thirteenth aspect, alone or in combination with one or more of the first through twelfth aspects, the first carrier comprises an anchor carrier and the second carrier comprises a non-anchor carrier. In a fourteenth aspect, alone or in combination with the thirteenth aspect, the non-anchor carrier comprises a synchronization signal block-less carrier. In a fifteenth aspect, alone or in combination with one or more of the first through fourteenth aspects, the first reference signal comprises at least one of a synchronization signal block or a channel state information reference signal.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 1002) performs operations associated with beam management for non-anchor carriers.

As shown in FIG. 14, in some aspects, process 1400 may include receiving a first reference signal using a first network transmit beam corresponding to a first carrier (block 1410). For example, the UE (e.g., using communication manager 1808 and/or reception component 1802, depicted in FIG. 18) may receive a first reference signal using a first network transmit beam corresponding to a first carrier, as described above.

As further shown in FIG. 14, in some aspects, process 1400 may include receiving, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier (block 1420). For example, the UE (e.g., using communication manager 1808 and/or reception component 1802, depicted in FIG. 18) may receive, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier, as described above.

Process 1400 may include additional aspects, such as any single aspect or any combination of aspects described below and/or in connection with one or more other processes described elsewhere herein.

In a first aspect, the beam metric comprises an angle divergence value equal to a difference between a first AoD associated with the first network transmit beam and a second AoD associated with the second network transmit beam. In a second aspect, alone or in combination with the first aspect, the beam metric satisfying the beam refinement condition is based on the angle divergence value being greater than or equal to a beam width of a reference network transmit beam corresponding to the second carrier. In a third aspect, alone or in combination with one or more of the first and second aspects, the reference network transmit beam comprises a network transmit beam associated with a relative power that is greater than or equal to a product of a peak power and an indicated multiplier.

In a fourth aspect, alone or in combination with one or more of the first through third aspects, the beam metric satisfying the beam refinement condition is further based on a frequency condition being satisfied. In a fifth aspect, alone or in combination with the fourth aspect, the frequency condition being satisfied is based on a frequency difference between a first frequency associated with the first carrier and a second frequency associated with the second carrier satisfying a frequency difference threshold.

In a sixth aspect, alone or in combination with one or more of the first through fifth aspects, the beam metric satisfying the beam refinement condition is further based on a beam direction condition being satisfied. In a seventh aspect, alone or in combination with the sixth aspect, the beam direction condition being satisfied is based on a beam deviation satisfying a beam deviation threshold, the beam deviation comprising an angle between a transmission direction associated with the second network transmit beam and a boresight direction associated with an antenna element from which the second network transmit beam is transmitted.

In an eighth aspect, alone or in combination with one or more of the first through seventh aspects, the beam metric satisfying the beam refinement condition is further based on a beam width condition being satisfied. In a ninth aspect, alone or in combination with the eighth aspect, the beam width condition being satisfied is based on a beam width of a reference network transmit beam, corresponding to the second carrier, satisfying a beam width threshold. In a tenth aspect, alone or in combination with the ninth aspect, the reference network transmit beam comprises a network transmit beam associated with a relative power is greater than or equal to a product of a peak power and an indicated multiplier.

In an eleventh aspect, alone or in combination with one or more of the first through tenth aspects, process 1400 includes receiving configuration information indicating a measurement reporting configuration associated with the first network transmit beam, and transmitting a measurement report associated with the first network transmit beam, wherein receiving the network transmit beam refinement procedure communication comprises receiving the network transmit beam refinement procedure communication based on receiving the measurement report.

In a twelfth aspect, alone or in combination with one or more of the first through eleventh aspects, process 1400 includes receiving a network transmit beam refinement procedure configuration associated with the network transmit beam refinement procedure, the network transmit beam refinement procedure configuration comprising configuration information associated with a beam sweeping operation.

In a thirteenth aspect, alone or in combination with the twelfth aspect, the network transmit beam refinement procedure configuration indicates a plurality of candidate network transmit beams, corresponding to the second carrier, associated with the beam sweeping operation. In a fourteenth aspect, alone or in combination with the thirteenth aspect, the network transmit beam refinement procedure configuration indicates a quantity of candidate network transmit beams of a plurality of candidate network transmit beams, corresponding to the second carrier, associated with the beam sweeping operation. In a fifteenth aspect, alone or in combination with one or more of the thirteenth or fourteenth aspects, the network transmit beam refinement procedure configuration indicates a sweeping order associated with a plurality of candidate network transmit beams, corresponding to the second carrier, associated with the beam sweeping operation.

In a sixteenth aspect, alone or in combination with one or more of the thirteenth through fifteenth aspects, process 1400 includes performing the beam sweeping operation. In a seventeenth aspect, alone or in combination with the sixteenth aspect, performing the beam sweeping operation comprises receiving a plurality of reference signals, wherein each reference signal of the plurality of reference signals is associated with a respective candidate network transmit beam of a plurality of candidate network transmit beams corresponding to the second carrier. In an eighteenth aspect, alone or in combination with the seventeenth aspect, receiving the plurality of reference signals comprises receiving the plurality of reference signals according to a descending order of signal strength associated with the plurality of candidate network transmit beams. In a nineteenth aspect, alone or in combination with the seventeenth aspect, receiving the plurality of reference signals comprises receiving the plurality of reference signals according to a random order of candidate network transmit beams of the plurality of candidate network transmit beams. In a twentieth aspect, alone or in combination with the seventeenth aspect, receiving the plurality of reference signals comprises receiving the plurality of reference signals according to a configured order of network transmit beam identifiers associated with the plurality of candidate network transmit beams.

In a twenty-first aspect, alone or in combination with one or more of the seventeenth through twentieth aspects, the plurality of candidate network transmit beams is based on an angle divergence value equal to a difference between a first AoD associated with the first network transmit beam and a second AoD associated with the second network transmit beam. In a twenty-second aspect, alone or in combination with one or more of the seventeenth through twenty-first aspects, the plurality of candidate network transmit beams is based on a mapping function that maps a set of signal measurements associated with the first carrier to the plurality of candidate network transmit beams. In a twenty-third aspect, alone or in combination with one or more of the sixteenth through twenty-second aspects, performing the beam sweeping operation comprises receiving a first beam refinement reference signal using a first candidate network transmit beam of a plurality of candidate network transmit beams corresponding to the second carrier, receiving a beam switch indication associated with switching from the first candidate network transmit beam to a second candidate network transmit beam, and receiving a second beam refinement reference signal using the second candidate network transmit beam.

In a twenty-fourth aspect, alone or in combination with one or more of the first through twenty-third aspects, the first carrier is an anchor carrier and the second carrier is a non-anchor carrier. In a twenty-fifth aspect, alone or in combination with the twenty-fourth aspect, the non-anchor carrier comprises a synchronization signal block-less carrier. In a twenty-sixth aspect, alone or in combination with one or more of the first through twenty-fifth aspects, the first reference signal comprises at least one of a synchronization signal block or a channel state information reference signal.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a network node, or a network node may include the apparatus 1500 (e.g., the apparatus may be at the network node). In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a network node, or another wireless communication device) using the reception component 1502 and the transmission component 1504. As further shown, the apparatus 1500 may include a communication manager 1508.

In some aspects, the apparatus 1500 may be configured to perform one or more operations described herein in connection with FIGS. 9 and 10. Additionally, or alternatively, the apparatus 1500 may be configured to perform one or more processes described herein, such as process 1100 of FIG. 11, process 1200 of FIG. 12, and/or one or more combinations thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, deployment engine 109-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for outputting, obtaining, transmitting, receiving, and/or performing may include various processing system components, such as a receive processor, a transmit processor, a controller/processor, a memory, or a combination thereof, of the network node described above in connection with FIG. 2.

The communication manager 1508 and/or the transmission component 1504 may transmit a first reference signal using a first network transmit beam corresponding to a first carrier. In some aspects, the communication manager 1508 may include one or more antennas, a modem, a controller/processor, a memory, or a combination thereof, of the network node described in connection with FIG. 2. In some aspects, the communication manager 1508 may include the reception component 1502 and/or the transmission component 1504. In some aspects, the communication manager 1508 may be, be similar to, include, or be included in, the communication manager 150 depicted in FIGS. 1 and 2. The communication manager 1508 and/or the transmission component 1504 may transmit, based on a beam metric associated with the first network transmit beam and a second network transmit beam corresponding to a second carrier, a network transmit beam refinement procedure indication indicating whether a network transmit beam refinement procedure is to be performed (e.g., indicating that the network transmit beam refinement procedure is to be performed or will fail to be performed).

The communication manager 1508, the reception component 1502 and/or the transmission component 1504 may communicate using the second network transmit beam, wherein a first TCI state associated with the first network transmit beam is equal to a second TCI state associated with the second network transmit beam. The communication manager 1508 and/or the transmission component 1504 may transmit configuration information indicating a measurement reporting configuration associated with the first network transmit beam. The communication manager 1508 and/or the reception component 1502 may receive a measurement report associated with the first network transmit beam, wherein transmitting the network transmit beam refinement procedure indication comprises transmitting the network transmit beam refinement procedure indication based on the measurement report. The communication manager 1508 and/or the transmission component 1504 may transmit a network transmit beam refinement procedure configuration associated with the network transmit beam refinement procedure, the network transmit beam refinement procedure configuration comprising configuration information associated with a beam sweeping operation. The communication manager 1508, the reception component 1502 and/or the transmission component 1504 may perform the beam sweeping operation.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

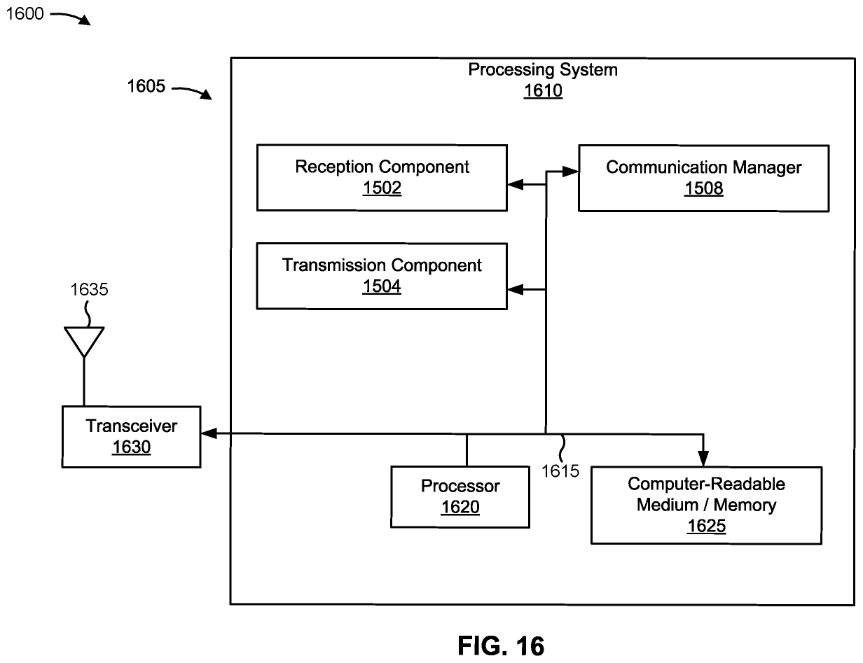

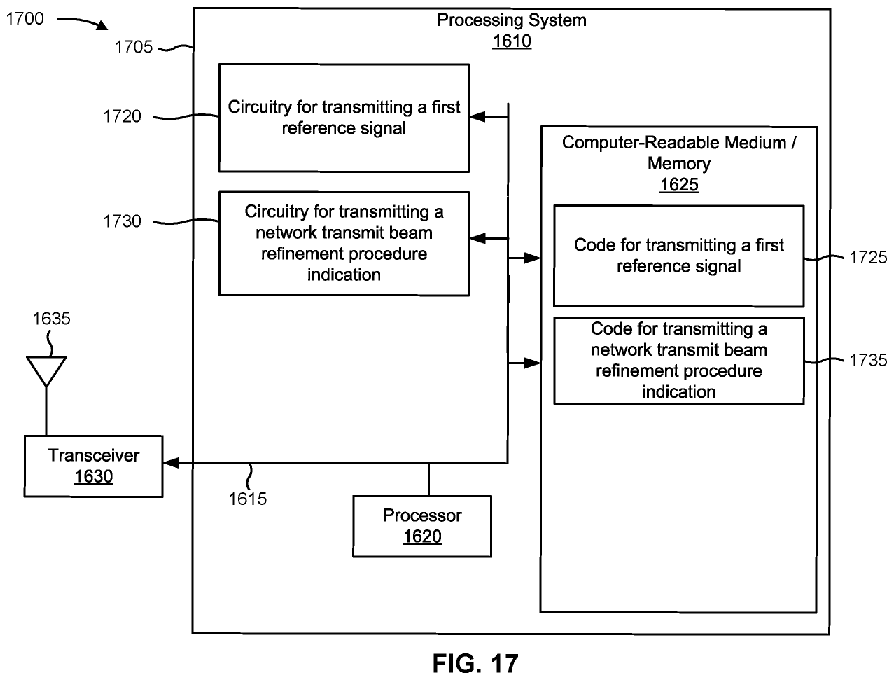

FIG. 16 is a diagram illustrating an example 1600 of a hardware implementation for an apparatus 1605 employing a processing system 1610, in accordance with the present disclosure. The apparatus 1605 may be a network node.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium/memory 1625. The bus 1615 may also link various other circuits, such as timing sources, peripherals, voltage regulators, and/or power management circuits.

The processing system 1610 may be coupled to a transceiver 1630. The transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes a processor 1620 coupled to a computer-readable medium/memory 1625. The processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. For example, the processing system includes the communication manager 1508. The components may be software modules running in the processor 1620, resident/stored in the computer readable medium/memory 1625, one or more hardware modules coupled to the processor 1620, or some combination thereof.

In some aspects, the processing system 1610 may be a component of the network node 110 and may include the memory 242 and/or at least one of the TX MIMO processor 230, the RX processor 238, and/or the controller/processor 240. In some aspects, the apparatus 1605 for wireless communication includes means for transmitting a first reference signal using a first network transmit beam corresponding to an anchor carrier; and transmitting, based on a beam measurement associated with the first network transmit beam and a second network transmit beam corresponding to a non-anchor carrier, a network transmit beam refinement procedure indication indicating whether a network transmit beam refinement procedure is to be performed. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 16 is provided as an example. Other examples may differ from what is described in connection with FIG. 16.

FIG. 17 is a diagram illustrating an example 1700 of an implementation of code and circuitry for an apparatus 1705, in accordance with the present disclosure. The apparatus 1705 may be a network node, or a network node may include the apparatus 1705.

As shown in FIG. 17, the apparatus 1705 may include circuitry for transmitting a first reference signal (circuitry 1720). For example, the circuitry 1720 may enable the apparatus 1705 to transmit a first reference signal using a first network transmit beam corresponding to a first carrier.

As shown in FIG. 17, the apparatus 1705 may include, stored in computer-readable medium 1625, code for transmitting a first reference signal (code 1725). For example, the code 1725, when executed by processor 1620, may cause processor 1620 to cause transceiver 1630 to transmit a first reference signal using a first network transmit beam corresponding to a first carrier.

As shown in FIG. 17, the apparatus 1705 may include circuitry for transmitting a network transmit beam refinement procedure indication (circuitry 1730). For example, the circuitry 1730 may enable the apparatus 1705 to transmit, based on a beam metric, a network transmit beam refinement procedure communication indicating whether a network transmit beam refinement procedure is to be performed, the beam metric being associated with the first network transmit beam and a second network transmit beam, the second network transmit beam corresponding to a second carrier.

As shown in FIG. 17, the apparatus 1705 may include, stored in computer-readable medium 1625, code for transmitting a network transmit beam refinement procedure indication (code 1735). For example, the code 1735, when executed by processor 1620, may cause processor 1620 to cause transceiver 1630 to transmit, based on a beam measurement associated with the first network transmit beam and a second network transmit beam corresponding to a non-anchor carrier, a network transmit beam refinement procedure indication indicating whether a network transmit beam refinement procedure is to be performed.

FIG. 17 is provided as an example. Other examples may differ from what is described in connection with FIG. 17.

FIG. 18 is a diagram of an example apparatus 1800 for wireless communication, in accordance with the present disclosure. The apparatus 1800 may be a UE, or a UE may include the apparatus 1800 (e.g., the apparatus may be at the UE). In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a network node, or another wireless communication device) using the reception component 1802 and the transmission component 1804. As further shown, the apparatus 1800 may include a communication manager 1808.

In some aspects, the apparatus 1800 may be configured to perform one or more operations described herein in connection with FIGS. 9 and 10. Additionally, or alternatively, the apparatus 1800 may be configured to perform one or more processes described herein, such as process 1300 of FIG. 13, process 1400 of FIG. 14, and/or one or more combinations thereof. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the UE described in connection with FIG. 2. In some aspects, the transmission component 1804 may be co-located with the reception component 1802 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for outputting, obtaining, transmitting, receiving, and/or performing may include various processing system components, such as a receive processor, a transmit processor, a controller/processor, a memory, or a combination thereof, of the UE described above in connection with FIG. 2.

The communication manager 1808 and/or the reception component 1802 may receive a first reference signal using a first network transmit beam corresponding to an anchor carrier. In some aspects, the communication manager 1808 may include one or more antennas, a modem, a controller/processor, a memory, or a combination thereof, of the UE described in connection with FIG. 2. In some aspects, the communication manager 1808 may include the reception component 1802 and/or the transmission component 1804. In some aspects, the communication manager 1808 may be, be similar to, include, or be included in, the communication manager 140 depicted in FIGS. 1 and 2. The communication manager 1808 and/or the reception component 1802 may receive, based on a beam measurement associated with the first network transmit beam and a second network transmit beam corresponding to a non-anchor carrier, a network transmit beam refinement procedure indication indicating whether a network transmit beam refinement procedure is to be performed.

The communication manager 1808, the reception component 1802, and/or the transmission component 1804 may communicate using the second network transmit beam, wherein a first TCI state associated with the first network transmit beam is equal to a second TCI state associated with the second network transmit beam. The communication manager 1808 and/or the reception component 1802 may receive configuration information indicating a measurement reporting configuration associated with the first network transmit beam. The communication manager 1808 and/or the transmission component 1804 may transmit a measurement report associated with the first network transmit beam, wherein receiving the network transmit beam refinement procedure indication comprises transmitting the network transmit beam refinement procedure indication based on the measurement report. The communication manager 1808 and/or the reception component 1802 may receive a network transmit beam refinement procedure configuration associated with the network transmit beam refinement procedure, the network transmit beam refinement procedure configuration comprising configuration information associated with a beam sweeping operation. The communication manager 1808, the reception component 1802, and/or the transmission component 1804 may perform the network transmit beam refinement procedure based on the beam sweeping operation.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

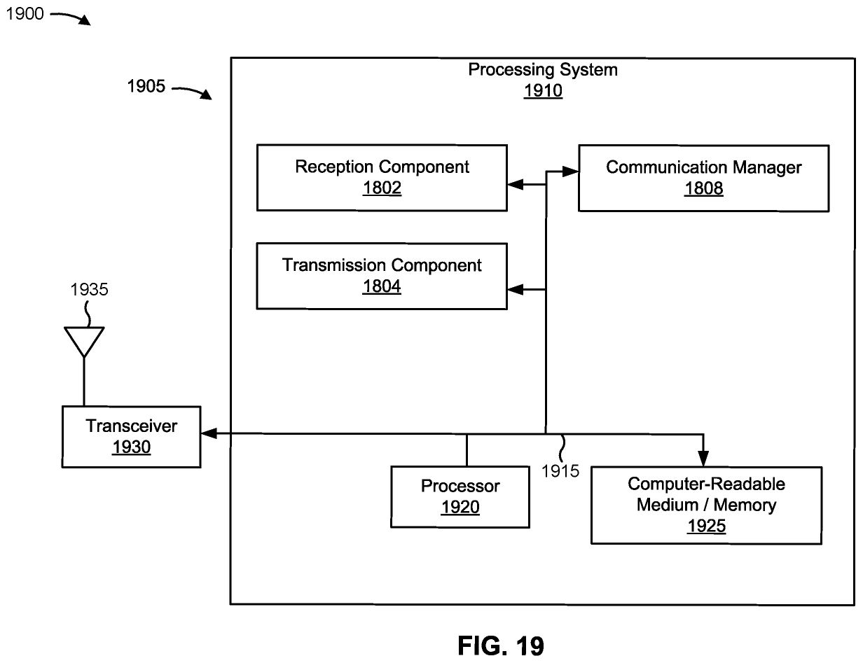

FIG. 19 is a diagram illustrating an example 1900 of a hardware implementation for an apparatus 1905 employing a processing system 1910, in accordance with the present disclosure. The apparatus 1905 may be a UE.

The processing system 1910 may be implemented with a bus architecture, represented generally by the bus 1915. The bus 1915 may include any number of interconnecting buses and bridges depending on the specific application of the processing system 1910 and the overall design constraints. The bus 1915 links together various circuits including one or more processors and/or hardware components, represented by the processor 1920, the illustrated components, and the computer-readable medium/memory 1925. The bus 1915 may also link various other circuits, such as timing sources, peripherals, voltage regulators, and/or power management circuits.

The processing system 1910 may be coupled to a transceiver 1930. The transceiver 1930 is coupled to one or more antennas 1935. The transceiver 1930 provides a means for communicating with various other apparatuses over a transmission medium. The transceiver 1930 receives a signal from the one or more antennas 1935, extracts information from the received signal, and provides the extracted information to the processing system 1910, specifically the reception component 1802. In addition, the transceiver 1930 receives information from the processing system 1910, specifically the transmission component 1804, and generates a signal to be applied to the one or more antennas 1935 based at least in part on the received information.

The processing system 1910 includes a processor 1920 coupled to a computer-readable medium/memory 1925. The processor 1920 is responsible for general processing, including the execution of software stored on the computer-readable medium/memory 1925. The software, when executed by the processor 1920, causes the processing system 1910 to perform the various functions described herein for any particular apparatus. The computer-readable medium/memory 1925 may also be used for storing data that is manipulated by the processor 1920 when executing software. The processing system further includes at least one of the illustrated components. For example, the processing system includes the communication manager 1808. The components may be software modules running in the processor 1920, resident/stored in the computer readable medium/memory 1925, one or more hardware modules coupled to the processor 1920, or some combination thereof.

In some aspects, the processing system 1910 may be a component of the UE 120 and may include the memory 282 and/or at least one of the TX MIMO processor 266, the RX processor 258, and/or the controller/processor 280. In some aspects, the apparatus 1905 for wireless communication includes means for receiving a first reference signal using a first network transmit beam corresponding to an anchor carrier; and receiving, based on a beam measurement associated with the first network transmit beam and a second network transmit beam corresponding to a non-anchor carrier, a network transmit beam refinement procedure indication indicating whether a network transmit beam refinement procedure is to be performed. The aforementioned means may be one or more of the aforementioned components of the apparatus 1600 and/or the processing system 1910 of the apparatus 1905 configured to perform the functions recited by the aforementioned means. As described elsewhere herein, the processing system 1910 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 19 is provided as an example. Other examples may differ from what is described in connection with FIG. 19.

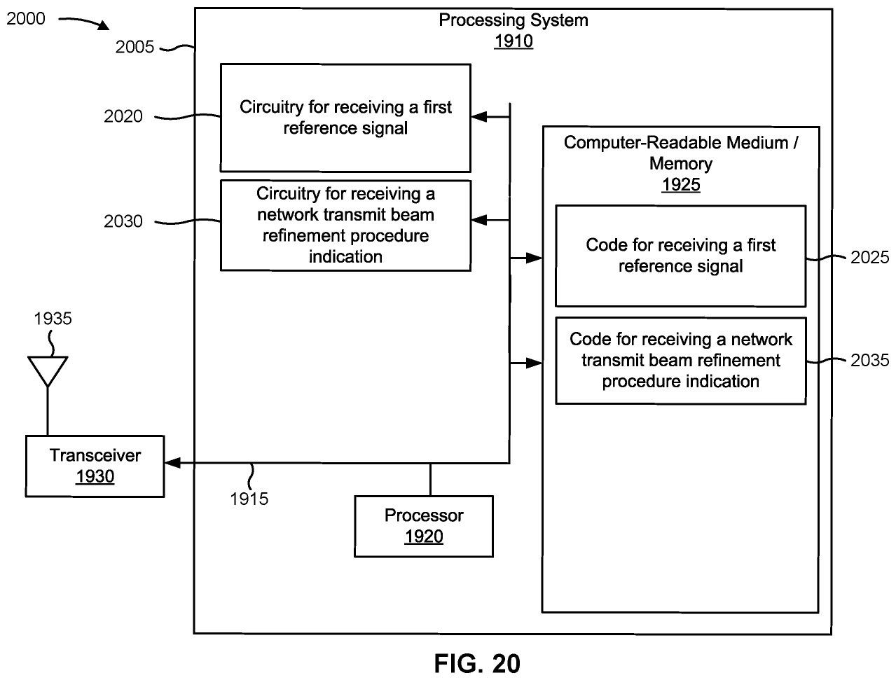

FIG. 20 is a diagram illustrating an example 2000 of an implementation of code and circuitry for an apparatus 2005, in accordance with the present disclosure. The apparatus 2005 may be a UE, or a UE may include the apparatus 2005.

As shown in FIG. 20, the apparatus 2005 may include circuitry for receiving a first reference signal using a first network transmit beam corresponding to an anchor carrier (circuitry 2020). For example, the circuitry 2020 may enable the apparatus 2005 to receive a first reference signal using a first network transmit beam corresponding to an anchor carrier.

As shown in FIG. 20, the apparatus 2005 may include, stored in computer-readable medium 1925, code for receiving a first reference signal (code 2025). For example, the code 2025, when executed by processor 1920, may cause processor 1920 to cause transceiver 1930 to receive a first reference signal associated with a first network transmit beam corresponding to a first carrier.

As shown in FIG. 20, the apparatus 2005 may include circuitry for receiving a network transmit beam refinement procedure indication (circuitry 2030). For example, the circuitry 2030 may enable the apparatus 2005 to receive, based on a beam metric associated with the first network transmit beam and a second network transmit beam corresponding to a second carrier, a network transmit beam refinement procedure indication indicating whether a network transmit beam refinement procedure is to be performed.

As shown in FIG. 20, the apparatus 2005 may include, stored in computer-readable medium 1925, code for receiving a network transmit beam refinement procedure indication (code 2035). For example, the code 2035, when executed by processor 1920, may cause processor 1920 to cause transceiver 1930 to receive, based on a beam metric associated with the first network transmit beam and a second network transmit beam corresponding to a second carrier, a network transmit beam refinement procedure indication indicating whether a network transmit beam refinement procedure is to be performed.

FIG. 20 is provided as an example. Other examples may differ from what is described in connection with FIG. 20.

The following provides an overview of some Aspects of the present disclosure:

Aspect 1: A method of wireless communication performed at a network node, comprising: transmitting a first reference signal using a first network transmit beam corresponding to a first carrier; and transmitting, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Aspect 2: The method of Aspect 1, further comprising communicating using the second network transmit beam, wherein a first transmission configuration indicator (TCI) state associated with the first network transmit beam is equal to a second TCI state associated with the second network transmit beam.

Aspect 3: The method of either of claim 1 or 2, wherein the beam metric comprises an angle divergence value equal to a difference between a first angle of departure (AoD) associated with the first network transmit beam and a second AoD associated with the second network transmit beam.

Aspect 4: The method of Aspect 3, wherein the beam metric failing to satisfy the beam refinement condition is based on the angle divergence value being less than a beam width of a reference network transmit beam corresponding to the second carrier.

Aspect 5: The method of Aspect 4, wherein the reference network transmit beam comprises a network transmit beam associated with a relative power that is greater than or equal to a product of a peak power and an indicated multiplier.

Aspect 6: The method of any of Aspects 1-5, wherein the beam metric failing to satisfy the beam refinement condition is further based on a frequency condition failing to be satisfied.

Aspect 7: The method of Aspect 6, wherein the frequency condition failing to be satisfied is based on a frequency difference between a first frequency associated with the first carrier and a second frequency associated with the second carrier failing to satisfy a frequency difference threshold.

Aspect 8: The method of any of Aspects 1-7, wherein the beam metric failing to satisfy the beam refinement condition is further based on a beam direction condition failing to be satisfied.

Aspect 9: The method of Aspect 8, wherein the beam direction condition failing to be satisfied is based on a beam deviation failing to satisfy a beam deviation threshold, the beam deviation comprising an angle between a transmission direction associated with the second network transmit beam and a boresight direction associated with an antenna element from which the second network transmit beam is transmitted.

Aspect 10: The method of any of Aspects 1-9, wherein the beam metric failing to satisfy the beam refinement condition is further based on a beam width condition failing to be satisfied.

Aspect 11: The method of Aspect 10, wherein the beam width condition failing to be satisfied is based on a beam width of a reference network transmit beam, corresponding to the second carrier, failing to satisfy a beam width threshold.

Aspect 12: The method of Aspect 11, wherein the reference network transmit beam comprises a network transmit beam associated with a relative power that is greater than or equal to a product of a peak power and an indicated multiplier.

Aspect 13: The method of any of Aspects 1-12, further comprising: transmitting configuration information indicating a measurement reporting configuration associated with the first network transmit beam; and receiving a measurement report associated with the first network transmit beam, wherein transmitting the network transmit beam refinement procedure communication comprises transmitting the network transmit beam refinement procedure communication based on receiving the measurement report.

Aspect 14: The method of any of Aspects 1-13, wherein the first carrier comprises an anchor carrier and the second carrier comprises a non-anchor carrier.

Aspect 15: The method of Aspect 14, wherein the non-anchor carrier comprises a synchronization signal block-less carrier.

Aspect 16: The method of any of Aspects 1-15, wherein the first reference signal comprises at least one of a synchronization signal block or a channel state information reference signal.

Aspect 17: A method of wireless communication performed at a network node, comprising: transmitting a first reference signal using a first network transmit beam corresponding to a first carrier; and transmitting, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Aspect 18: The method of Aspect 17, wherein the beam metric comprises an angle divergence value equal to a difference between a first angle of departure (AoD) associated with the first network transmit beam and a second AoD associated with the second network transmit beam.

Aspect 19: The method of Aspect 18, wherein the beam metric satisfying the beam refinement condition is based on the angle divergence value being greater than or equal to a beam width of a reference network transmit beam corresponding to the second carrier.

Aspect 20: The method of Aspect 19, wherein the reference network transmit beam comprises a network transmit beam associated with a relative power that is greater than or equal to a product of a peak power and an indicated multiplier.

Aspect 21: The method of any of Aspects 17-20, wherein the beam metric satisfying the beam refinement condition is further based on a frequency condition being satisfied.

Aspect 22: The method of Aspect 21, wherein the frequency condition being satisfied is based on a frequency difference between a first frequency associated with the first carrier and a second frequency associated with the second carrier satisfying a frequency difference threshold.

Aspect 23: The method of any of Aspects 17-22, wherein the beam metric satisfying the beam refinement condition is further based on a beam direction condition being satisfied.

Aspect 24: The method of Aspect 23, wherein the beam direction condition being satisfied is based on a beam deviation satisfying a beam deviation threshold, the beam deviation comprising an angle between a transmission direction associated with the second network transmit beam and a boresight direction associated with an antenna element from which the second network transmit beam is transmitted.

Aspect 25: The method of any of Aspects 17-24, wherein the beam metric satisfying the beam refinement condition is further based on a beam width condition being satisfied.

Aspect 26: The method of Aspect 25, wherein the beam width condition being satisfied is based on a beam width of a reference network transmit beam, corresponding to the second carrier, satisfying a beam width threshold.

Aspect 27: The method of Aspect 26, wherein the reference network transmit beam comprises a network transmit beam associated with a relative power is greater than or equal to a product of a peak power and an indicated multiplier.

Aspect 28: The method of any of Aspects 17-27, further comprising: transmitting configuration information indicating a measurement reporting configuration associated with the first network transmit beam; and receiving a measurement report associated with the first network transmit beam, wherein transmitting the network transmit beam refinement procedure communication comprises transmitting the network transmit beam refinement procedure communication based on receiving the measurement report.

Aspect 29: The method of any of Aspects 17-28, further comprising transmitting a network transmit beam refinement procedure configuration associated with the network transmit beam refinement procedure, the network transmit beam refinement procedure configuration comprising configuration information associated with a beam sweeping operation.

Aspect 30: The method of Aspect 29, wherein the network transmit beam refinement procedure configuration indicates a plurality of candidate network transmit beams, corresponding to the second carrier, associated with the beam sweeping operation.

Aspect 31: The method of Aspect 30, wherein the network transmit beam refinement procedure configuration indicates a quantity of candidate network transmit beams of a plurality of candidate network transmit beams, corresponding to the second carrier, associated with the beam sweeping operation.

Aspect 32: The method of either of Aspects 30 or 31, wherein the network transmit beam refinement procedure configuration indicates a sweeping order associated with a plurality of candidate network transmit beams, corresponding to the second carrier, associated with the beam sweeping operation.

Aspect 33: The method of any of Aspects 30-32, further comprising performing the beam sweeping operation.

Aspect 34: The method of Aspect 33, wherein performing the beam sweeping operation comprises transmitting a plurality of reference signals, wherein each reference signal of the plurality of reference signals is associated with a respective candidate network transmit beam of a plurality of candidate network transmit beams corresponding to the second carrier.

Aspect 35: The method of Aspect 34, wherein transmitting the plurality of reference signals comprises transmitting the plurality of reference signals according to a descending order of signal strength associated with the plurality of candidate network transmit beams.

Aspect 36: The method of Aspect 34, wherein transmitting the plurality of reference signals comprises transmitting the plurality of reference signals according to a random order of candidate network transmit beams of the plurality of candidate network transmit beams.

Aspect 37: The method of Aspect 34, wherein transmitting the plurality of reference signals comprises transmitting the plurality of reference signals according to a configured order of network transmit beam identifiers associated with the plurality of candidate network transmit beams.

Aspect 38: The method of any of Aspects 34-37, wherein the plurality of candidate network transmit beams is based on an angle divergence value equal to a difference between a first angle of departure (AoD) associated with the first network transmit beam and a second AoD associated with the second network transmit beam.

Aspect 39: The method of any of Aspects 34-38, wherein the plurality of candidate network transmit beams is based on a mapping function that maps a set of signal measurements associated with the first carrier to the plurality of candidate network transmit beams.

Aspect 40: The method of any of Aspects 33-39, wherein performing the beam sweeping operation comprises: transmitting a first beam refinement reference signal using a first candidate network transmit beam of a plurality of candidate network transmit beams corresponding to the second carrier; transmitting a beam switch indication associated with switching from the first candidate network transmit beam to a second candidate network transmit beam; and transmitting a second beam refinement reference signal using the second candidate network transmit beam.

Aspect 41: The method of any of Aspects 17-40, wherein the first carrier is an anchor carrier and the second carrier is a non-anchor carrier.

Aspect 42: The method of Aspect 41, wherein the non-anchor carrier comprises a synchronization signal block-less carrier.

Aspect 43: The method of any of Aspects 17-42, wherein the first reference signal comprises at least one of a synchronization signal block or a channel state information reference signal.

Aspect 44: A method of wireless communication performed at a user equipment (UE), comprising: receiving a first reference signal using a first network transmit beam corresponding to a first carrier; and receiving, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

Aspect 45: The method of Aspect 44, further comprising communicating using the second network transmit beam, wherein a first transmission configuration indicator (TCI) state associated with the first network transmit beam is equal to a second TCI state associated with the second network transmit beam.

Aspect 46: The method of either of claim 44 or 45, wherein the beam metric comprises an angle divergence value equal to a difference between a first angle of departure (AoD) associated with the first network transmit beam and a second AoD associated with the second network transmit beam.

Aspect 47: The method of Aspect 46, wherein the beam metric failing to satisfy the beam refinement condition is based on the angle divergence value being less than a beam width of a reference network transmit beam corresponding to the second carrier.

Aspect 48: The method of Aspect 47, wherein the reference network transmit beam comprises a network transmit beam associated with a relative power that is greater than or equal to a product of a peak power and an indicated multiplier.

Aspect 49: The method of any of Aspects 44-48, wherein the beam metric failing to satisfy the beam refinement condition is further based on a frequency condition failing to be satisfied.

Aspect 50: The method of Aspect 49, wherein the frequency condition failing to be satisfied is based on a frequency difference between a first frequency associated with the first carrier and a second frequency associated with the second carrier failing to satisfy a frequency difference threshold.

Aspect 51: The method of any of Aspects 44-50, wherein the beam metric failing to satisfy the beam refinement condition is further based on a beam direction condition failing to be satisfied.

Aspect 52: The method of Aspect 51, wherein the beam direction condition failing to be satisfied is based on a beam deviation failing to satisfy a beam deviation threshold, the beam deviation comprising an angle between a transmission direction associated with the second network transmit beam and a boresight direction associated with an antenna element from which the second network transmit beam is transmitted.

Aspect 53: The method of any of Aspects 44-52, wherein the beam metric failing to satisfy the beam refinement condition is further based on a beam width condition failing to be satisfied.

Aspect 54: The method of Aspect 53, wherein the beam width condition failing to be satisfied is based on a beam width of a reference network transmit beam, corresponding to the second carrier, failing to satisfy a beam width threshold.

Aspect 55: The method of Aspect 54, wherein the reference network transmit beam comprises a network transmit beam associated with a relative power that is greater than or equal to a product of a peak power and an indicated multiplier.

Aspect 56: The method of any of Aspects 44-55, further comprising: receiving configuration information indicating a measurement reporting configuration associated with the first network transmit beam; and transmitting a measurement report associated with the first network transmit beam, wherein receiving the network transmit beam refinement procedure communication comprises receiving the network transmit beam refinement procedure communication based on receiving the measurement report.

Aspect 57: The method of any of Aspects 44-56, wherein the first carrier comprises an anchor carrier and the second carrier comprises a non-anchor carrier.

Aspect 58: The method of Aspect 57, wherein the non-anchor carrier comprises a synchronization signal block-less carrier.

Aspect 59: The method of any of Aspects 44-58, wherein the first reference signal comprises at least one of a synchronization signal block or a channel state information reference signal.

Aspect 60: A method of wireless communication performed at a user equipment (UE), comprising: receiving a first reference signal using a first network transmit beam corresponding to a first carrier; and receiving, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

Aspect 61: The method of Aspect 60, wherein the beam metric comprises an angle divergence value equal to a difference between a first angle of departure (AoD) associated with the first network transmit beam and a second AoD associated with the second network transmit beam.

Aspect 62: The method of Aspect 61, wherein the beam metric satisfying the beam refinement condition is based on the angle divergence value being greater than or equal to a beam width of a reference network transmit beam corresponding to the second carrier.

Aspect 63: The method of Aspect 62, wherein the reference network transmit beam comprises a network transmit beam associated with a relative power that is greater than or equal to a product of a peak power and an indicated multiplier.

Aspect 64: The method of any of Aspects 60-63, wherein the beam metric satisfying the beam refinement condition is further based on a frequency condition being satisfied.

Aspect 65: The method of Aspect 64, wherein the frequency condition being satisfied is based on a frequency difference between a first frequency associated with the first carrier and a second frequency associated with the second carrier satisfying a frequency difference threshold.

Aspect 66: The method of any of Aspects 60-65, wherein the beam metric satisfying the beam refinement condition is further based on a beam direction condition being satisfied.

Aspect 67: The method of Aspect 66, wherein the beam direction condition being satisfied is based on a beam deviation satisfying a beam deviation threshold, the beam deviation comprising an angle between a transmission direction associated with the second network transmit beam and a boresight direction associated with an antenna element from which the second network transmit beam is transmitted.

Aspect 68: The method of any of Aspects 60-67, wherein the beam metric satisfying the beam refinement condition is further based on a beam width condition being satisfied.

Aspect 69: The method of Aspect 68, wherein the beam width condition being satisfied is based on a beam width of a reference network transmit beam, corresponding to the second carrier, satisfying a beam width threshold.

Aspect 70: The method of Aspect 69, wherein the reference network transmit beam comprises a network transmit beam associated with a relative power is greater than or equal to a product of a peak power and an indicated multiplier.

Aspect 71: The method of any of Aspects 60-70, further comprising: receiving configuration information indicating a measurement reporting configuration associated with the first network transmit beam; and transmitting a measurement report associated with the first network transmit beam, wherein receiving the network transmit beam refinement procedure communication comprises receiving the network transmit beam refinement procedure communication based on receiving the measurement report.

Aspect 72: The method of any of Aspects 60-71, further comprising receiving a network transmit beam refinement procedure configuration associated with the network transmit beam refinement procedure, the network transmit beam refinement procedure configuration comprising configuration information associated with a beam sweeping operation.

Aspect 73: The method of Aspect 72, wherein the network transmit beam refinement procedure configuration indicates a plurality of candidate network transmit beams, corresponding to the second carrier, associated with the beam sweeping operation.

Aspect 74: The method of Aspect 73, wherein the network transmit beam refinement procedure configuration indicates a quantity of candidate network transmit beams of a plurality of candidate network transmit beams, corresponding to the second carrier, associated with the beam sweeping operation.

Aspect 75: The method of either of Aspects 73 or 74, wherein the network transmit beam refinement procedure configuration indicates a sweeping order associated with a plurality of candidate network transmit beams, corresponding to the second carrier, associated with the beam sweeping operation.

Aspect 76: The method of any of Aspects 73-75, further comprising performing the beam sweeping operation.

Aspect 77: The method of Aspect 76, wherein performing the beam sweeping operation comprises receiving a plurality of reference signals, wherein each reference signal of the plurality of reference signals is associated with a respective candidate network transmit beam of a plurality of candidate network transmit beams corresponding to the second carrier.

Aspect 78: The method of Aspect 77, wherein receiving the plurality of reference signals comprises receiving the plurality of reference signals according to a descending order of signal strength associated with the plurality of candidate network transmit beams.

Aspect 79: The method of Aspect 77, wherein receiving the plurality of reference signals comprises receiving the plurality of reference signals according to a random order of candidate network transmit beams of the plurality of candidate network transmit beams.

Aspect 80: The method of Aspect 77, wherein receiving the plurality of reference signals comprises receiving the plurality of reference signals according to a configured order of network transmit beam identifiers associated with the plurality of candidate network transmit beams.

Aspect 81: The method of any of Aspects 77-80, wherein the plurality of candidate network transmit beams is based on an angle divergence value equal to a difference between a first angle of departure (AoD) associated with the first network transmit beam and a second AoD associated with the second network transmit beam.

Aspect 82: The method of any of Aspects 77-81, wherein the plurality of candidate network transmit beams is based on a mapping function that maps a set of signal measurements associated with the first carrier to the plurality of candidate network transmit beams.

Aspect 83: The method of any of Aspects 76-82, wherein performing the beam sweeping operation comprises: receiving a first beam refinement reference signal using a first candidate network transmit beam of a plurality of candidate network transmit beams corresponding to the second carrier; receiving a beam switch indication associated with switching from the first candidate network transmit beam to a second candidate network transmit beam; and receiving a second beam refinement reference signal using the second candidate network transmit beam.

Aspect 84: The method of any of Aspects 60-83, wherein the first carrier is an anchor carrier and the second carrier is a non-anchor carrier.

Aspect 85: The method of Aspect 84, wherein the non-anchor carrier comprises a synchronization signal block-less carrier.

Aspect 86: The method of any of Aspects 60-85, wherein the first reference signal comprises at least one of a synchronization signal block or a channel state information reference signal.

Aspect 87: An apparatus for wireless communication at a device, comprising a processor; memory coupled with the processor; and instructions stored in the memory and executable by the processor to cause the apparatus to perform the method of one or more of Aspects 1-16.

Aspect 88: A device for wireless communication, comprising a memory and one or more processors coupled to the memory, the one or more processors configured to perform the method of one or more of Aspects 1-16.

Aspect 89: An apparatus for wireless communication, comprising at least one means for performing the method of one or more of Aspects 1-16.

Aspect 90: A non-transitory computer-readable medium storing code for wireless communication, the code comprising instructions executable by a processor to perform the method of one or more of Aspects 1-16.

Aspect 91: A non-transitory computer-readable medium storing a set of instructions for wireless communication, the set of instructions comprising one or more instructions that, when executed by one or more processors of a device, cause the device to perform the method of one or more of Aspects 1-16.

Aspect 92: An apparatus for wireless communication at a device, comprising a processor; memory coupled with the processor; and instructions stored in the memory and executable by the processor to cause the apparatus to perform the method of one or more of Aspects 17-43.

Aspect 93: A device for wireless communication, comprising a memory and one or more processors coupled to the memory, the one or more processors configured to perform the method of one or more of Aspects 17-43.

Aspect 94: An apparatus for wireless communication, comprising at least one means for performing the method of one or more of Aspects 17-43.

Aspect 95: A non-transitory computer-readable medium storing code for wireless communication, the code comprising instructions executable by a processor to perform the method of one or more of Aspects 17-43.

Aspect 96: A non-transitory computer-readable medium storing a set of instructions for wireless communication, the set of instructions comprising one or more instructions that, when executed by one or more processors of a device, cause the device to perform the method of one or more of Aspects 17-43.

Aspect 97: An apparatus for wireless communication at a device, comprising a processor; memory coupled with the processor; and instructions stored in the memory and executable by the processor to cause the apparatus to perform the method of one or more of Aspects 44-59.

Aspect 98: A device for wireless communication, comprising a memory and one or more processors coupled to the memory, the one or more processors configured to perform the method of one or more of Aspects 44-59.

Aspect 99: An apparatus for wireless communication, comprising at least one means for performing the method of one or more of Aspects 44-59.

Aspect 100: A non-transitory computer-readable medium storing code for wireless communication, the code comprising instructions executable by a processor to perform the method of one or more of Aspects 44-59.

Aspect 101: A non-transitory computer-readable medium storing a set of instructions for wireless communication, the set of instructions comprising one or more instructions that, when executed by one or more processors of a device, cause the device to perform the method of one or more of Aspects 44-59.

Aspect 102: An apparatus for wireless communication at a device, comprising a processor; memory coupled with the processor; and instructions stored in the memory and executable by the processor to cause the apparatus to perform the method of one or more of Aspects 60-86.

Aspect 103: A device for wireless communication, comprising a memory and one or more processors coupled to the memory, the one or more processors configured to perform the method of one or more of Aspects 60-86.

Aspect 104: An apparatus for wireless communication, comprising at least one means for performing the method of one or more of Aspects 60-86.

Aspect 105: A non-transitory computer-readable medium storing code for wireless communication, the code comprising instructions executable by a processor to perform the method of one or more of Aspects 60-86.

Aspect 106: A non-transitory computer-readable medium storing a set of instructions for wireless communication, the set of instructions comprising one or more instructions that, when executed by one or more processors of a device, cause the device to perform the method of one or more of Aspects 60-86.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus at a network node for wireless communication, comprising:
a memory; and
one or more processors coupled to the memory, the one or more processors configured to:
output for transmission a first reference signal using a first network transmit beam corresponding to a first carrier; and
output for transmission, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

2. The apparatus of claim 1, wherein the one or more processors are further configured to communicate using the second network transmit beam, wherein a first transmission configuration indicator (TCI) state associated with the first network transmit beam is equal to a second TCI state associated with the second network transmit beam.

3. The apparatus of claim 1, wherein the beam metric comprises an angle divergence value equal to a difference between a first angle of departure (AoD) associated with the first network transmit beam and a second AoD associated with the second network transmit beam.

4. The apparatus of claim 3, wherein the beam metric failing to satisfy the beam refinement condition is based on the angle divergence value being less than a beam width of a reference network transmit beam corresponding to the second carrier.

5. The apparatus of claim 1, wherein the beam metric failing to satisfy the beam refinement condition is further based on a frequency condition failing to be satisfied.

6. The apparatus of claim 1, wherein the beam metric failing to satisfy the beam refinement condition is further based on a beam direction condition failing to be satisfied.

7. The apparatus of claim 1, wherein the beam metric failing to satisfy the beam refinement condition is further based on a beam width condition failing to be satisfied.

8. The apparatus of claim 1, wherein the one or more processors are further configured to:
output for transmission configuration information indicating a measurement reporting configuration associated with the first network transmit beam; and
obtain a measurement report associated with the first network transmit beam, wherein the one or more processors, to transmit the network transmit beam refinement procedure communication, are configure to transmit the network transmit beam refinement procedure communication based on the measurement report.

9. The apparatus of claim 1, wherein the first carrier comprises an anchor carrier and the second carrier comprises a non-anchor carrier.

10. The apparatus of claim 9, wherein the non-anchor carrier comprises a synchronization signal block-less carrier.

11. The apparatus of claim 1, wherein the first reference signal comprises at least one of a synchronization signal block or a channel state information reference signal.

12. An apparatus at a network node for wireless communication, comprising:
a memory; and
one or more processors coupled to the memory, the one or more processors configured to:
output for transmission a first reference signal using a first network transmit beam corresponding to a first carrier; and
output for transmission, based on a beam metric satisfying a beam refinement condition, wherein a network transmit beam refinement procedure communication indicates that a network transmit beam refinement procedure is to be performed, the beam metric being associated with the first network transmit beam and a second network transmit beam, the second network transmit beam corresponding to a second carrier.

13. The apparatus of claim 12, wherein the beam metric comprises an angle divergence value equal to a difference between a first angle of departure (AoD) associated with the first network transmit beam and a second AoD associated with the second network transmit beam.

14. The apparatus of claim 13, wherein the beam metric satisfying the beam refinement condition is based on the angle divergence value being greater than or equal to a beam width of a reference network transmit beam corresponding to the second carrier.

15. The apparatus of claim 14, wherein the reference network transmit beam comprises a network transmit beam associated with a relative power that is greater than or equal to a product of a peak power and an indicated multiplier.

16. The apparatus of claim 15, wherein the beam metric satisfying the beam refinement condition is further based on a frequency condition being satisfied.

17. The apparatus of claim 16, wherein the frequency condition being satisfied is based on a frequency difference between a first frequency associated with the first carrier and a second frequency associated with the second carrier satisfying a frequency difference threshold.

18. The apparatus of claim 15, wherein the beam metric satisfying the beam refinement condition is further based on a beam direction condition being satisfied.

19. The apparatus of claim 18, wherein the beam direction condition being satisfied is based on a beam deviation satisfying a beam deviation threshold, the beam deviation comprising an angle between a transmission direction associated with the second network transmit beam and a boresight direction associated with an antenna element from which the second network transmit beam is transmitted.

20. The apparatus of claim 15, wherein the beam metric satisfying the beam refinement condition is further based on a beam width condition being satisfied.

21. The apparatus of claim 20, wherein the beam width condition being satisfied is based on a beam width of a reference network transmit beam, corresponding to the second carrier, satisfying a beam width threshold.

22. The apparatus of claim 21, wherein the reference network transmit beam comprises a network transmit beam associated with a relative power is greater than or equal to a product of a peak power and an indicated multiplier.

23. The apparatus of claim 15, wherein the one or more processors are further configured to:
output for transmission configuration information indicating a measurement reporting configuration associated with the first network transmit beam; and
obtain a measurement report associated with the first network transmit beam, wherein the one or more processors, to transmit the network transmit beam refinement procedure communication, are configured to transmit the network transmit beam refinement procedure communication based on the measurement report.

24. The apparatus of claim 15, wherein the one or more processors are further configured to output for transmission a network transmit beam refinement procedure configuration associated with the network transmit beam refinement procedure, the network transmit beam refinement procedure configuration comprising configuration information associated with a beam sweeping operation.

25. An apparatus at a user equipment (UE) for wireless communication, comprising:
a memory; and
one or more processors coupled to the memory, the one or more processors configured to:
obtain a first reference signal using a first network transmit beam corresponding to a first carrier; and
obtain, based on a beam metric failing to satisfy a beam refinement condition, a network transmit beam refinement procedure communication indicating that a network transmit beam refinement procedure will fail to be performed, the beam metric being associated with the first network transmit beam and a second network transmit beam, the second network transmit beam corresponding to a second carrier.

26. The apparatus of claim 25, wherein the one or more processors are further configured to communicate using the second network transmit beam, wherein a first transmission configuration indicator (TCI) state associated with the first network transmit beam is equal to a second TCI state associated with the second network transmit beam.

27. An apparatus at a user equipment (UE) for wireless communication, comprising:
a memory; and
one or more processors coupled to the memory, the one or more processors configured to:
obtain a first reference signal using a first network transmit beam corresponding to a first carrier; and
obtain, based on a beam metric satisfying a beam refinement condition, a network transmit beam refinement procedure communication indicating that a network transmit beam refinement procedure is to be performed, the beam metric being associated with the first network transmit beam and a second network transmit beam, the second network transmit beam corresponding to a second carrier.

28. The apparatus of claim 27, wherein the network transmit beam refinement procedure configuration indicates a plurality of candidate network transmit beams, corresponding to the second carrier, associated with the beam sweeping operation.

29. The apparatus of claim 28, wherein the one or more processors are further configured to perform the beam sweeping operation, wherein the one or more processors, to perform the beam sweeping operation, are configure to output for transmission a plurality of reference signals, wherein each reference signal of the plurality of reference signals is associated with a respective candidate network transmit beam of a plurality of candidate network transmit beams corresponding to the second carrier.

30. The UE of claim 29, wherein the one or more processors are further configured to obtain a network transmit beam refinement procedure configuration associated with the network transmit beam refinement procedure, the network transmit beam refinement procedure configuration comprising configuration information associated with a beam sweeping operation.
